(19) United States
(12) Patent Application Publication
(10) Pub. No.: US 2014/0105295 A1
(43) Pub. Date: Apr. 17, 2014

(54) MOVING IMAGE ENCODING METHOD AND APPARATUS, AND MOVING IMAGE DECODING METHOD AND APPARATUS

(71) Applicant: KABUSHIKI KAISHA TOSHIBA, Minato-ku (JP)

(72) Inventors: Taichiro SHIODERA, Tokyo (JP); Akiyuki Tanizawa, Kawasaki-shi (JP)

(73) Assignee: KABUSHIKI KAISHA TOSHIBA, Minato-ku (JP)

(21) Appl. No.: 14/106,044

(22) Filed: Dec. 13, 2013

Related U.S. Application Data
(63) Continuation of application No. PCT/JP2011/063738, filed on Jun. 15, 2011.

(51) Int. Cl. H04N 19/51

(52) U.S. Cl. CPC H04N 19/00696
USPC 375/240.14

(57) ABSTRACT

According to one embodiment, there is provided a moving image encoding method for performing an inter prediction. The method includes acquiring first predicted motion information and second predicted motion information from an encoded region including blocks including motion information and generating, if a first condition is satisfied, a predicted image of a target block using one of (1) the first predicted motion information and third predicted motion information, the third predicted motion information being acquired from the encoded region and being different from the first predicted motion information and the second predicted motion information, and (2) one of the first predicted motion information and the second predicted motion information.

### CROSS REFERENCE TO RELATED APPLICATIONS

This application is a Continuation application of PCT Application No. PCT/JP2011/063738, filed Jun. 15, 2011, the entire contents of which are incorporated herein by reference.

### FIELD

Embodiments described herein relate generally to a moving image encoding method and apparatus, and a moving image decoding method and apparatus.

### BACKGROUND

Recently, an image encoding method in which an encoding efficiency is greatly improved is recommended as ITU-T Rec. H.264 and ISO/IEC 14496-10 (hereinafter, referred to as H.264) in cooperation with ITU-T and ISO/IEC. In H.264, prediction processing, transform processing, and entropy encoding processing are performed in rectangular block units (for example, a 16×16 pixel block unit and an 8×8 pixel block unit).

In the prediction processing, motion compensation is performed to a rectangular block (an encoding target block) of an encoding target. In the motion compensation, a prediction in a temporal direction is performed by referring to an already-encoded frame (a reference frame). In the motion compensation, it is necessary to encode and transmit motion information including a motion vector to a decoding side. The motion vector is information on a spatial shift between the encoding target block and a block referred to in the reference frame. In addition, when the motion compensation is performed using a plurality of reference frames, it is necessary to encode reference frame numbers in addition to the motion information. Therefore, a code amount related to the motion information and the reference frame number may increase.

Further, a motion information prediction method that derives predicted motion information of an encoding target block by referring to motion information stored in a motion information memory of a reference frame is known (see JP-B 4020789 and B. Bross et al, “BoG report of CE9: MV Coding and Skip/Merge operations”, Joint Collaborative Team on Video Coding (JCT-VC) of ITU-T SG16 WP3 and ISO/IEC JTC1/SC29/WG11 Document, JCTVC-E481, March 2011. (hereinafter, referred to as Bross)).

However, according to the derivation method of predicted motion information disclosed in Bross, a problem of the same block being referred to by two kinds of predicted motion information used for bidirectional prediction is posed.

### BRIEF DESCRIPTION OF THE DRAWINGS

FIG. 1 is a block diagram schematically illustrating a moving image encoding apparatus according to a first embodiment;

FIG. 2 is a view illustrating an order in which the moving image encoding apparatus in FIG. 1 performs encoding;

FIG. 3A is a view illustrating an example of a size of a pixel block;

FIG. 3B is a view illustrating another example of the size of the pixel block;

FIG. 3C is a view illustrating still another example of the size of the pixel block;

FIG. 4A is a view illustrating a coding tree unit whose block size is 64×64 pixels.

FIG. 4B is a view illustrating an example of quadtree segmentation of the coding tree unit in FIG. 4A;

FIG. 4C is a view illustrating one coding tree unit after the quadtree segmentation shown in FIG. 4B;

FIG. 4D is a view illustrating an example of quadtree segmentation of the coding tree unit in FIG. 4C;

FIG. 5 is a block diagram illustrating an entropy encoder illustrated in FIG. 1 in more detail;

FIG. 6 is a block diagram illustrating a motion information memory illustrated in FIG. 1 in more detail;

FIG. 7A is a view illustrating an example of a method in which an inter-predictor illustrated in FIG. 1 generates a predicted image;

FIG. 7B is a view illustrating another example of the method in which the inter-predictor illustrated in FIG. 1 generates a predicted image;

FIG. 8A is a view illustrating an example of a relationship between the coding tree unit and a prediction unit;

FIG. 8B is a view illustrating another example of the relationship between the coding tree unit and the prediction unit;

FIG. 8C is a view illustrating still another example of the relationship between the coding tree unit and the prediction unit;

FIG. 8D is a view illustrating still another example of the relationship between the coding tree unit and the prediction unit;

FIG. 8E is a view illustrating still another example of the relationship between the coding tree unit and the prediction unit;

FIG. 8F is a view illustrating still another example of the relationship between the coding tree unit and the prediction unit;

FIG. 8G is a view illustrating still another example of the relationship between the coding tree unit and the prediction unit;

FIG. 9 is a diagram showing a skip mode, a merge mode, and an inter mode used by the moving image encoding apparatus in FIG. 1;

FIG. 10 is a block diagram illustrating a predicted motion information acquiring module illustrated in FIG. 1 in more detail;

FIG. 11A is a view illustrating an example of a position of an adjacent prediction unit referred to by a reference motion information acquiring module illustrated in FIG. 10 to generate a predicted motion information candidate and positioned in a spatial direction;

FIG. 11B is a view illustrating another example of the position of the adjacent prediction unit referred to by the reference motion information acquiring module illustrated in FIG. 10 to generate a predicted motion information candidate and positioned in the spatial direction;

FIG. 12 is a view illustrating an example of a position of an adjacent prediction unit referred to by the reference motion information acquiring module illustrated in FIG. 10 to generate a predicted motion information candidate and positioned in a temporal direction;

FIG. 13A is a diagram showing an example of the relationship between index Mvpidx and a block position of a predicted motion information candidate generated by the reference motion information acquiring module illustrated in FIG. 10;

FIG. 13B is a diagram showing another example of the relationship between index Mvpidx and the block position of the predicted motion information candidate generated by the reference motion information acquiring module illustrated in FIG. 10;

FIG. 13C is a diagram showing still another example of the relationship between index Mvpidx and the block position of the predicted motion information candidate generated by the reference motion information acquiring module illustrated in FIG. 10;

FIG. 14A is a view illustrating an example of a reference motion information acquisition position when an encoding target prediction unit is a 32×32 pixel block;

FIG. 14B is a view illustrating an example of the reference motion information acquisition position when the encoding target prediction unit is a 32×16 pixel block;

FIG. 14C is a view illustrating an example of the reference motion information acquisition position when the encoding target prediction unit is a 16×32 pixel block;

FIG. 14D is a view illustrating an example of the reference motion information acquisition position when the encoding target prediction unit is a 16×16 pixel block;

FIG. 14E is a view illustrating an example of the reference motion information acquisition position when the encoding target prediction unit is a 16×8 pixel block;

FIG. 14F is a view illustrating an example of the reference motion information acquisition position when the encoding target prediction unit is an 8×16 pixel block;

FIG. 15A is a view illustrating another example of the reference motion information acquisition position when the encoding target prediction unit is the 32×32 pixel block;

FIG. 15B is a view illustrating another example of the reference motion information acquisition position when the encoding target prediction unit is the 32×16 pixel block;

FIG. 15C is a view illustrating another example of the reference motion information acquisition position when the encoding target prediction unit is the 16×32 pixel block;

FIG. 15D is a view illustrating another example of the reference motion information acquisition position when the encoding target prediction unit is the 16×16 pixel block;

FIG. 15E is a view illustrating another example of the reference motion information acquisition position when the encoding target prediction unit is the 16×8 pixel block;

FIG. 15F is a view illustrating another example of the reference motion information acquisition position when the encoding target prediction unit is the 8×16 pixel block;

FIG. 16A is a view illustrating still another example of the reference motion information acquisition position when the encoding target prediction unit is the 32×32 pixel block;

FIG. 16B is a view illustrating still another example of the reference motion information acquisition position when the encoding target prediction unit is the 32×16 pixel block;

FIG. 16C is a view illustrating still another example of the reference motion information acquisition position when the encoding target prediction unit is the 16×32 pixel block;

FIG. 16D is a view illustrating still another example of the reference motion information acquisition position when the encoding target prediction unit is the 16×16 pixel block;

FIG. 16E is a view illustrating still another example of the reference motion information acquisition position when the encoding target prediction unit is the 16×8 pixel block;

FIG. 16F is a view illustrating still another example of the reference motion information acquisition position when the encoding target prediction unit is the 8×16 pixel block;

FIG. 17A is a view illustrating still another example of the reference motion information acquisition position when the encoding target prediction unit is the 32×32 pixel block;

FIG. 17B is a view illustrating still another example of the reference motion information acquisition position when the encoding target prediction unit is the 32×16 pixel block;

FIG. 17C is a view illustrating still another example of the reference motion information acquisition position when the encoding target prediction unit is the 16×32 pixel block;

FIG. 17D is a view illustrating still another example of the reference motion information acquisition position when the encoding target prediction unit is the 16×16 pixel block;

FIG. 17E is a view illustrating still another example of the reference motion information acquisition position when the encoding target prediction unit is the 16×8 pixel block;

FIG. 17F is a view illustrating still another example of the reference motion information acquisition position when the encoding target prediction unit is the 8×16 pixel block;

FIG. 18 is a flow chart illustrating an example of processing of a predicted motion information setting module illustrated in FIG. 10;

FIG. 19 is a view showing a method of setting a reference frame number by the predicted motion information setting module illustrated in FIG. 10;

FIG. 20 is a flow chart illustrating another example of processing of the predicted motion information setting module illustrated in FIG. 10;

FIG. 21A is a view illustrating an example of the relationship between a first reference motion information acquisition position and a second reference motion information acquisition position;

FIG. 21B is a view illustrating another example of the relationship between the first reference motion information acquisition position and the second reference motion information acquisition position;

FIG. 21C is a view illustrating still another example of the relationship between the first reference motion information acquisition position and the second reference motion information acquisition position;

FIG. 22 is a flow chart illustrating still another example of processing of the predicted motion information setting module illustrated in FIG. 10;

FIG. 23 is a flow chart illustrating still another example of processing of the predicted motion information setting module illustrated in FIG. 10;

FIG. 24A is a diagram illustrating an example of a reference frame configuration when a weighted prediction is applied to the inter-predictor illustrated in FIG. 1;

FIG. 24B is a diagram illustrating another example of the reference frame configuration when the weighted prediction is applied to the inter-predictor illustrated in FIG. 1;

FIG. 25 is a block diagram illustrating a motion information encoder illustrated in FIG. 5 in detail;

FIG. 26 is a diagram illustrating an example of syntax used by the moving image encoding apparatus in FIG. 1;

FIG. 27 is a view illustrating an example of prediction unit syntax illustrated in FIG. 26;

FIG. 28 is a block diagram schematically illustrating a moving image decoding apparatus according to a second embodiment;

FIG. 29 is a block diagram illustrating an entropy decoder illustrated in FIG. 28 in more detail;

FIG. 30 is a block diagram illustrating a motion information decoder illustrated in FIG. 29 in more detail;

FIG. 31 is a block diagram illustrating a predicted motion information acquiring module illustrated in FIG. 28 in more detail;

FIG. 32 is a flow chart illustrating an example of processing of a predicted motion information setting module illustrated in FIG. 31;

FIG. 33 is a flow chart illustrating another example of processing of the predicted motion information setting module illustrated in FIG. 31;

FIG. 34 is a flow chart illustrating still another example of processing of the predicted motion information setting module illustrated in FIG. 31; and

FIG. 35 is a flow chart illustrating still another example of processing of the predicted motion information setting module illustrated in FIG. 31.

### DETAILED DESCRIPTION

According to one embodiment, there is provided a moving image encoding method for performing an inter prediction. The method includes acquiring first predicted motion information and second predicted motion information from an encoded region including blocks including motion information. The method further includes generating, if a first condition is satisfied, a predicted image of a target block using one of (1) the first predicted motion information and third predicted motion information, the third predicted motion information being acquired from the encoded region and being different from the first predicted motion information and the second predicted motion information, and (2) one of the first predicted motion information and the second predicted motion information. The first condition includes at least one of (A) a reference frame referred to by the first predicted motion information and a reference frame referred to by the second predicted motion information are identical, (B) a block referred to by the first predicted motion information and a block referred to by the second predicted motion information are identical, (C) a reference frame number contained in the first predicted motion information and a reference frame number contained in the second predicted motion information are identical, (D) a motion vector contained in the first predicted motion information and a motion vector contained in the second predicted motion information are identical, and (E) an absolute value of a difference between the motion vector contained in the first predicted motion information and the motion vector contained in the second predicted motion information is equal to or less than a predetermined value.

A moving image encoding method and apparatus and a moving image decoding method and apparatus according to some embodiments will be described below by referring to the accompanying drawings. A moving image encoding apparatus according to an embodiment will be described as the first embodiment and a moving image decoding apparatus corresponding to the moving image encoding apparatus will be described as the second embodiment. The term “image” used herein may be replaced by terms like “moving image”, “pixel”, “image signal”, and “image data” when appropriate. In the embodiments, like reference numbers denote like elements, and duplicate descriptions thereof are omitted.

### First Embodiment

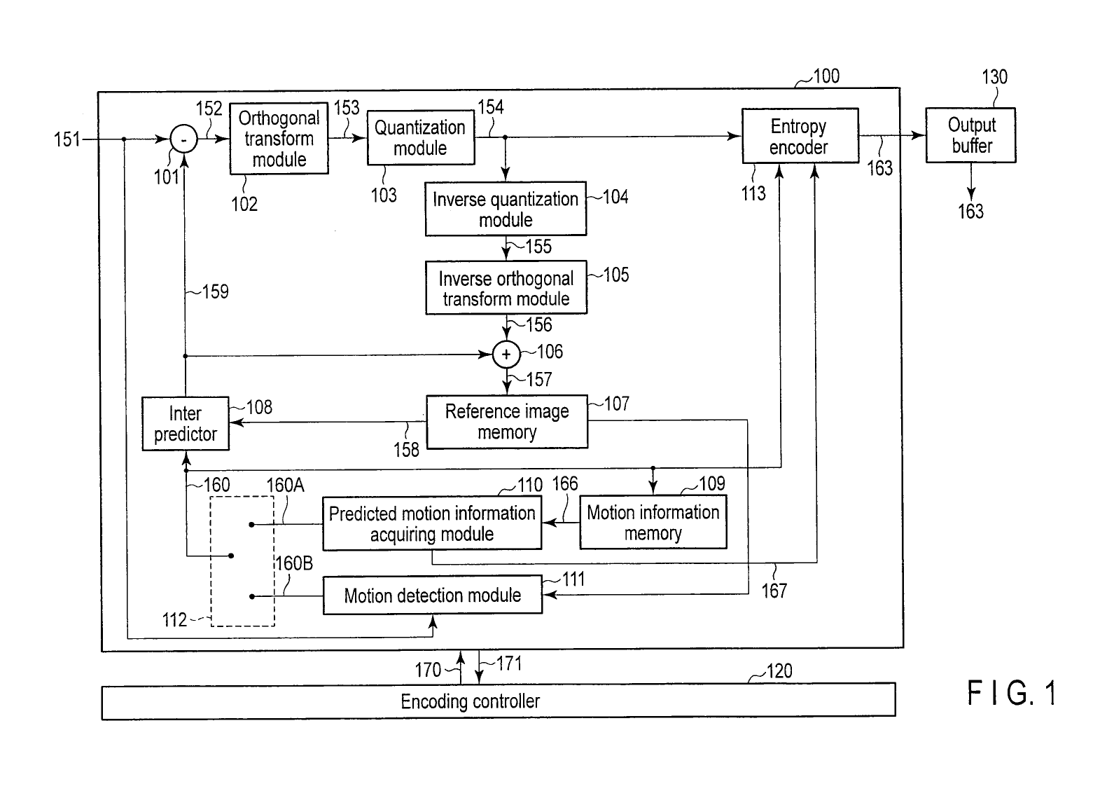

FIG. 1 schematically illustrates a moving image encoding apparatus 100 according to the first embodiment. A moving image encoding apparatus 100 includes, as illustrated in FIG. 1, a subtractor 101, an orthogonal transform module 102, a quantization module 103, an inverse quantization module 104, an inverse orthogonal transform module 105, an adder 106, a reference image memory 107, an inter-predictor 108, a motion information memory 109, a predicted motion information acquiring module 110, a motion detection module 111, a motion information selection switch 112, and an entropy encoder 113.

The moving image encoding apparatus 100 in FIG. 1 can be realized by hardware such as an LSI (Large-Scale Integration circuit) chip, DSP (Digital Signal Processor), and FPGA (Field Programmable Gate Array). The moving image encoding apparatus 100 can also be realized by causing a computer to execute an image encoding program.

An encoding controller 120 that controls the moving image encoding apparatus 100 and an output buffer 130 that temporarily stores encoded data 163 output from the moving image encoding apparatus 100 are normally provided outside the moving image encoding apparatus 100. However, the encoding controller 120 and the output buffer 130 may be included in the moving image encoding apparatus 100.

The encoding controller 120 controls the entire encoding processing of the moving image encoding apparatus 100, namely, feedback control of a generated code amount, quantization control, prediction mode control, and entropy encoding control. More specifically, the encoding controller 120 provides encoding control information 170 to the moving image encoding apparatus 100 and receives feedback information 171 from the moving image encoding apparatus 100. The encoding control information 170 contains prediction information, motion information, and quantization information. The prediction information includes prediction mode information and block size information. The motion information includes a motion vector, a reference frame number, and a prediction direction (a unidirectional prediction and a bidirectional prediction). The quantization information includes a quantization parameter and a quantization matrix. The feedback information 171 contains information about the generated code amount at the moving image encoding apparatus 100. The generated code amount is used, for example, to decide the quantization parameter.

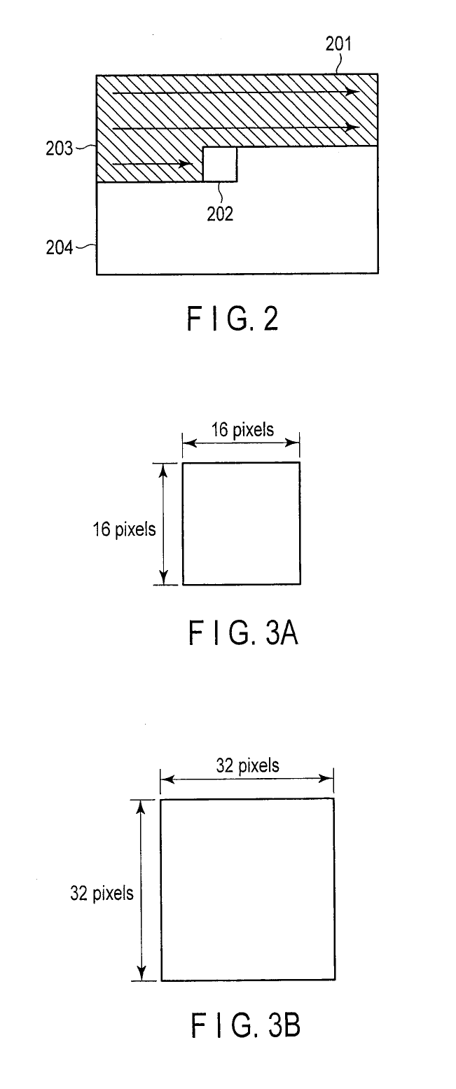

An input image signal 151 is provided to the moving image encoding apparatus 100 in FIG. 1 from outside. The input image signal 151 is, for example, moving image data. The moving image encoding apparatus 100 divides each frame (or each field or each slice) forming the input image signal 151 into a plurality of pixel blocks and prediction encoding of each divided pixel block is performed to generate the encoded data 163. More specifically, the moving image encoding apparatus 100 further includes a division module (not illustrated) that divides input image signal 151 into a plurality of pixel blocks. The division module supplies the plurality of pixel blocks obtained by dividing the input image signal 151 to the subtractor 101 in a predetermined order. In the present embodiment, as illustrated in FIG. 2, prediction encoding of pixel blocks is performed in a raster scan order, namely, in the order from the upper left to the lower right of an encoding target frame 201. When prediction encoding is performed in the raster scan order, encoded pixel blocks are positioned on the left side and the upper side of an encoding target block 202 in the encoding target frame 201. The encoding target block 202 indicates a pixel block as a target of encoding processing after being supplied to the subtractor 101 and the encoding target frame indicates a frame to which an encoding target block belongs. In FIG. 2, an encoded region 203 formed from encoded pixel blocks is illustrated as a diagonally shaded region. A region 204 other than the encoded region 203 is a non-encoded region.

The pixel block used herein indicates the processing unit for encoding an image like, for example, an L×M (L-by-M) size block (L and M are natural numbers), a coding tree unit, a macro block, a sub-block, and one pixel. In the present embodiment, the pixel block is basically used in the sense of a coding tree unit. Note, however, that the pixel block can also be interpreted in the above sense by appropriately replacing the description. The processing unit of encoding is not limited to the example of a pixel block as a coding tree unit, and a frame, a field, a slice, or a combination thereof may also be used.

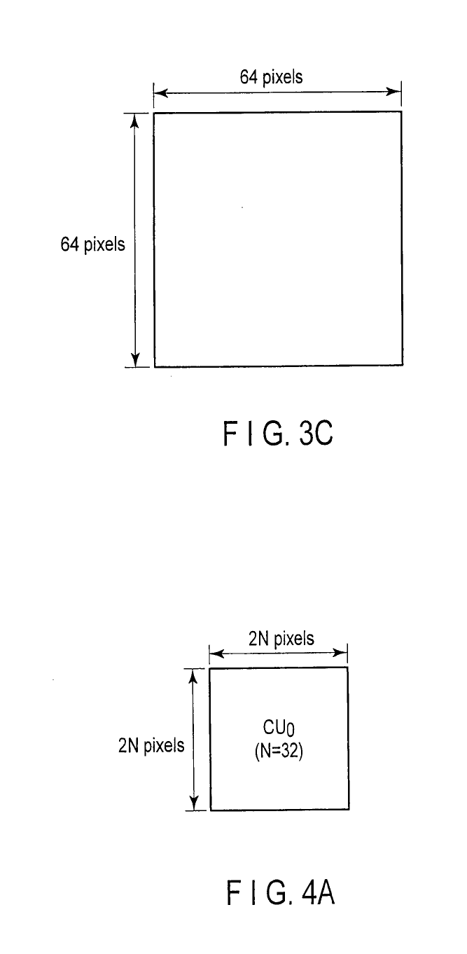

Typically, the coding tree unit is a 16×16 pixel block illustrated in FIG. 3A. The coding tree unit may be a 32×32 pixel block illustrated in FIG. 3B, a 64×64 pixel block illustrated in FIG. 3C, an 8×8 pixel block (not illustrated), or a 4×4 pixel block (not illustrated). In addition, the coding tree unit does not necessarily need to be a square pixel block. Hereinafter, an encoding target block or a coding tree unit of the input image signal 151 may be called a “prediction target block”.

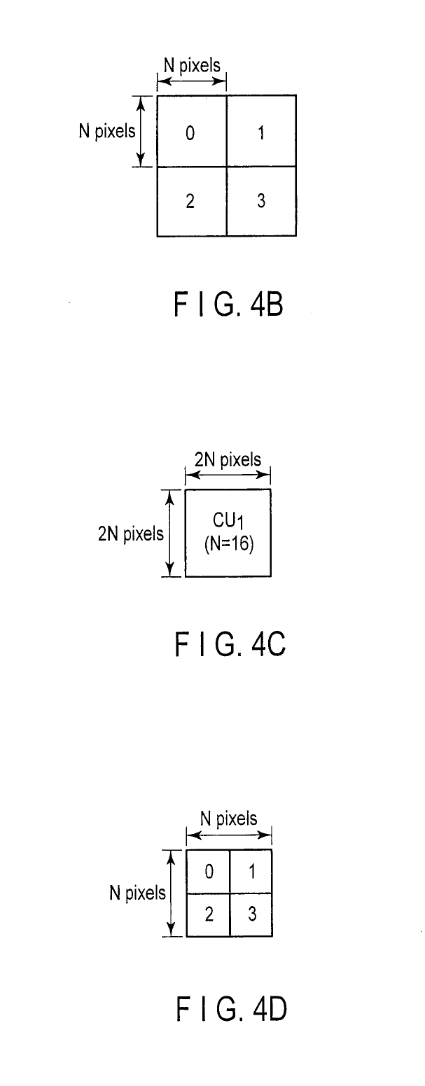

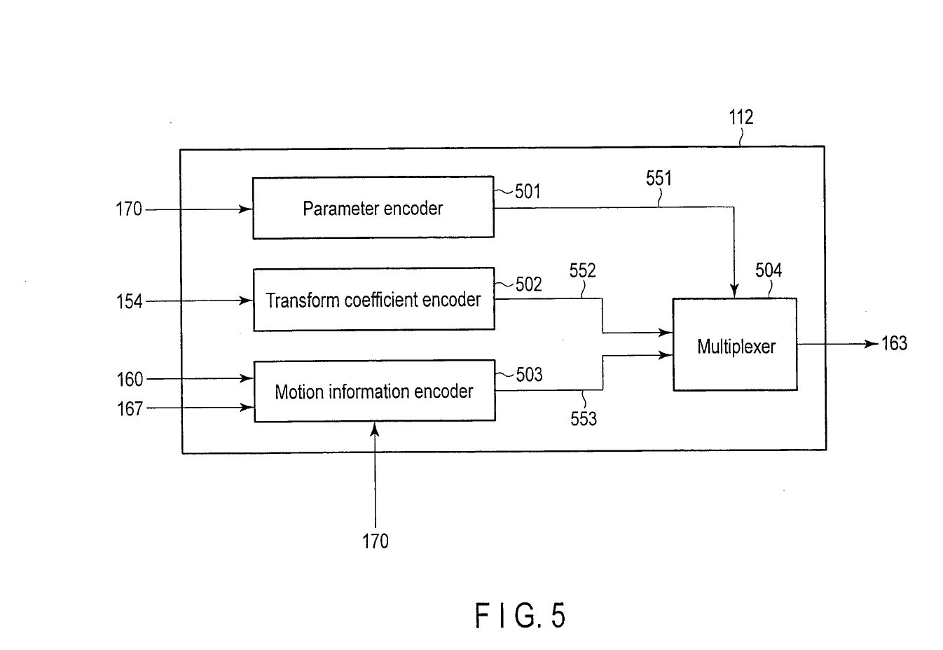

The coding tree unit will be described more concretely by referring to FIGS. 4A to 4D. FIG. 4A illustrates, as an example of the coding tree unit, a coding tree unit CU₀ whose block size is 64×64 pixels. The coding tree unit CU₀ has a quadtree structure. That is, the coding tree unit CU₀ can recursively be divided into four pixel blocks. In the present embodiment, a natural number N representing the size of the coding tree unit as a reference is introduced and the size of each pixel block obtained by quadtree segmentation is defined as N×N pixels. If defined as described above, the size of a coding tree unit before quadtree segmentation is represented as 2N×2N pixels. The coding tree unit CU₀ in FIG. 4A is a case of N=32.

FIG. 4B illustrates an example of quadtree segmentation of the coding tree unit CU₀ in FIG. 4A. An index is provided to four pixel blocks (coding tree units) obtained by quadtree segmentation in a Z-scan order. The number illustrated in each pixel block of FIG. 4B represents the Z-scan order. Each pixel block obtained by quadtree segmentation can further be quadtree-segmented. In the present embodiment, a depth of the segmentation is represented by Depth. For example, the coding tree unit CU₀ in FIG. 4A is a coding tree unit of Depth=0.

FIG. 4C illustrates a coding tree unit CU₁ having Depth=1. The coding tree unit CU₁ corresponds to one of four pixel blocks obtained by quadtree segmentation of the coding tree unit CU₁ in FIG. 4A. The size of the coding tree unit CU₁ is 32×32 pixels. Namely, this is a case of N=16. As illustrated in FIG. 4D, the coding tree unit CU₁ can further be quadtree-segmented. In this manner, a coding tree unit can recursively be quadtree-segmented until the block size reaches, for example, 8×8 pixels (N=4).

The largest coding tree unit of these coding tree units is called a large coding tree unit or a tree block. In this unit, the input image signal 151 is encoded in the raster scan order in the moving image encoding apparatus 100. Incidentally, the large coding tree unit is not limited to an example of a 64×64 pixel block and may be a pixel block of any size. In addition, the minimum coding tree unit is not limited to an example of an 8×8 pixel block and may be a pixel block of any size smaller than the size of the large coding tree unit.

The moving image encoding apparatus 100 in FIG. 1 encodes the input image signal 151 by selectively applying a plurality of prediction modes in which block sizes and generation methods of a predicted image signal 159 are mutually different. The generation method of the predicted image signal 159 can roughly be divided into two methods: an intra prediction that makes a prediction in an encoding target frame and an inter prediction that makes a prediction using one or a plurality of reference frames (already-encoded frames) that are temporally different.

The moving image encoding apparatus 100 performs an inter prediction or an intra prediction of each pixel block obtained by dividing the input image signal 151 based on encoding parameters provided by the encoding controller 120 to generate the predicted image signal 159 corresponding to the pixel block. The inter prediction is also called an inter-image prediction, an inter-frame prediction, or a motion compensation prediction. The intra prediction is also called an intra-image prediction or an intra-frame prediction. More specifically, the moving image encoding apparatus 100 selectively uses the inter-predictor 108 that performs an inter prediction or an intra-predictor (not illustrated) that performs an intra prediction to generate the predicted image signal 159 corresponding to a pixel block. Subsequently, the moving image encoding apparatus 100 performs an orthogonal transform and quantization of a prediction error signal 152 representing a difference between the pixel block and the predicted image signal 159 to generate a quantized transform coefficient 154. Further, the moving image encoding apparatus 100 performs entropy encoding of the quantized transform coefficient 154 to generate the encoded data 163.

Next, each element contained in the moving image encoding apparatus 100 in FIG. 1 will be described.

The subtractor 101 subtracts the predicted image signal 159 from an encoding target block of the input image signal 151 to generate the prediction error signal 152. The subtractor 101 outputs the prediction error signal 152 to the orthogonal transform module 102.

The orthogonal transform module 102 performs an orthogonal transform of the prediction error signal 152 from the subtractor 101 to generate a transform coefficient 153. As the orthogonal transform, for example, the discrete cosine transform (DCT), the Hadamard transform, the wavelet transform, or the independent component analysis can be used. The orthogonal transform module 102 outputs the transform coefficient 153 to the quantization module 103.

The quantization module 103 quantizes the transform coefficient 153 from the orthogonal transform module 102 to generate the quantized transform coefficient 154. More specifically, the quantization module 103 quantizes the transform coefficient 153 according to quantization information including a quantization parameter and a quantization matrix. The quantization parameter and the quantization matrix needed for quantization are specified by the encoding controller 120. The quantization parameter indicates fineness of quantization. The quantization matrix is used to assign weights of fineness of quantization to each component of the transform coefficient. The quantization matrix does not necessarily need to be used. Use or non-use of the quantization matrix is not an essential part of the embodiment. The quantization module 103 outputs the quantized transform coefficient 154 to the entropy encoder 113 and the inverse quantization module 104.

The entropy encoder 113 performs entropy encoding (for example, Huffman coding, arithmetic coding or the like) of the quantized transform coefficient 154 from the quantization module 103, motion information 160 from a motion information selection switch 112 described below, and encoding parameters such as prediction information and quantization information specified by the encoding controller 120. The encoding parameters are parameters needed for decoding and include prediction information, the motion information 160, information about the transform coefficient (the quantized transform coefficient 154), and information about quantization (quantization information). For example, the encoding controller 120 includes an internal memory (not illustrated), encoding parameters are stored in the memory, and encoding parameters applied to encoded pixel blocks adjacent to the prediction target block can be used to encode the prediction target block.

FIG. 5 illustrates the entropy encoder 113 in more detail. The entropy encoder 113 includes, as illustrated in FIG. 5, a parameter encoder 501, a transform coefficient encoder 502, a motion information encoder 503, and a multiplexer 504.

The parameter encoder 501 encodes the encoding parameters contained in the encoding control information 170 from the encoding controller 120 to generate encoded data 551. The encoding parameters encoded by the parameter encoder 501 include prediction information and quantization information. The transform coefficient encoder 502 encodes the quantized transform coefficient 154 received from the quantization module 103 to generate encoded data 552.

The motion information encoder 503 encodes the motion information 160 applied to the inter-predictor 108 to generate encoded data 553 by referring to predicted motion information 167 received from the predicted motion information acquiring module 110 and a predicted motion information position contained in the encoding control information 170 from the encoding controller 120. The motion information encoder 503 will be described in detail later.

The multiplexer 504 multiplexes the encoded data 551, 552, 553 to generate the encoded data 163. The generated encoded data 163 contains all parameters needed for decoding the motion information 160, prediction information, information about the transform coefficient (the quantized transform coefficient 154), quantization information and the like.

As illustrated in FIG. 1, the encoded data 163 generated by the entropy encoder 113 is temporarily stored in the output buffer 130 and output at an appropriate output timing managed by the encoding controller 120. The encoded data 163 is transmitted to, for example, a storage system (storage medium) or a transmission system (communication line) (not illustrated).

The inverse quantization module 104 inversely quantizes the quantized transform coefficient 154 received from the quantization module 103 to generate a restored transform coefficient 155. More specifically, the inverse quantization module 104 inversely quantizes the quantized transform coefficient 154 according to the same quantization information as that used by the quantization module 103. The quantization information used by the inverse quantization module 104 is loaded from the internal memory of the encoding controller 120. The inverse quantization module 104 outputs the restored transform coefficient 155 to the inverse orthogonal transform module 105.

The inverse orthogonal transform module 105 performs an inverse orthogonal transform corresponding to the orthogonal transform performed by the orthogonal transform module 102 of the restored transform coefficient 155 from the inverse quantization module 104 to generate a restored prediction error signal 156. If, for example, the orthogonal transform by the orthogonal transform module 102 is the discrete cosine transform (DCT), the inverse orthogonal transform module 105 performs an inverse discrete cosine transform (IDCT). The inverse orthogonal transform module 105 outputs the restored prediction error signal 156 to the adder 106.

The adder 106 adds the restored prediction error signal 156 and the corresponding predicted image signal 159 to generate a locally-decoded image signal 157. The decoded image signal 157 is transmitted to the reference image memory 107 after filtering processing being performed thereon. For the filtering of the decoded image signal 157, for example, a deblocking filter or a Wiener filter is used.

The reference image memory 107 stores the decoded image signal 157 after the filtering processing. The decoded image signal 157 stored in the reference image memory 107 is referred to by the inter-predictor 108 as a reference image signal 158 to generate a predicted image.

The inter-predictor 108 performs an inter prediction using the reference image signal 158 stored in the reference image memory 107. More specifically, the inter-predictor 108 generates an inter predicted image by performing motion compensation (interpolation processing if motion compensation with decimal pixel accuracy is possible) based on the motion information 160 indicating an amount of shifts of motion between the prediction target block and the reference image signal 158. For example, in H.264, interpolation processing can be performed up to the ¼ pixel accuracy.

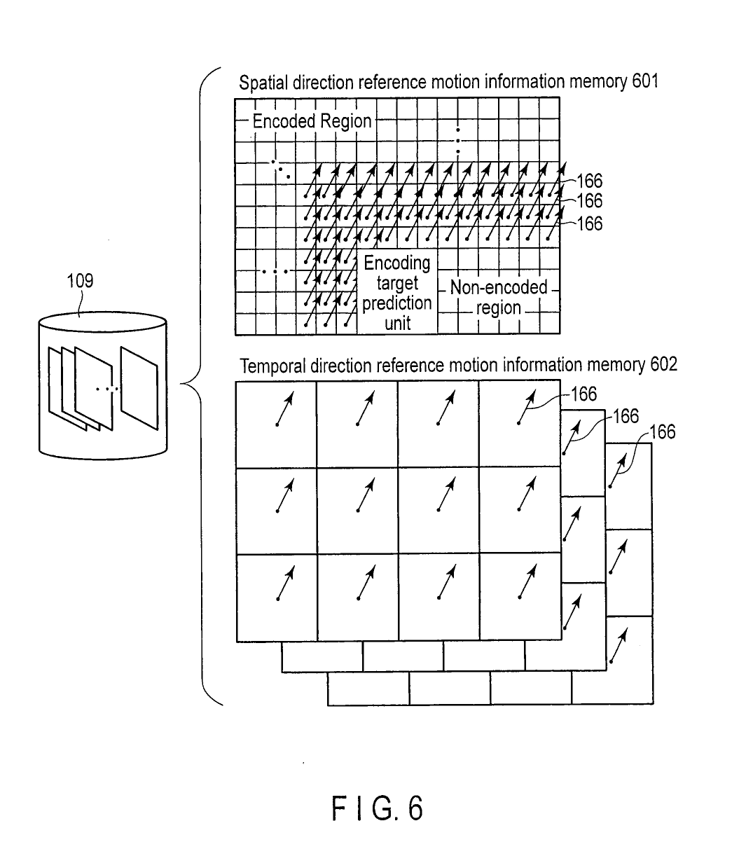

The motion information memory 109 temporarily stores the motion information 160 as reference motion information 166. The motion information memory 109 may reduce the amount of information by performing compression processing such as sub-sampling of the motion information 160. The reference motion information 166 is stored in frame (or slice) units. More specifically, as illustrated in FIG. 6, the motion information memory 109 includes a spatial direction reference motion information memory 601 that stores the motion information 160 of an encoding target frame as the reference motion information 166 and a temporal direction reference motion information memory 602 that stores the motion information 160 of an encoded frame as the reference motion information 166. As many temporal direction reference motion information memories 602 as reference frames used for predicting the encoding target frame can be provided.

The spatial direction reference motion information memory 601 and the temporal direction reference motion information memory 602 may be provided on the same memory by logically partitioning physically the same memory. Further, the spatial direction reference motion information memory 601 may hold only spatial direction motion information needed for encoding an encoding target frame so that spatial direction motion information that is no longer referred to for encoding the encoding target frame is successively compressed and stored in the temporal direction reference motion information memory 602.

The reference motion information 166 is stored in the spatial direction reference motion information memory 601 and the temporal direction reference motion information memory 602 in predetermined region units (for example, the 4×4 pixel block unit). The reference motion information 166 further contains information indicating which of the inter prediction and the intra prediction is applied to the region thereof.

In skip mode, direct mode, or merge mode described later defined in H.264, the value of a motion vector in the motion information 160 is not encoded. Even when an inter prediction of a coding tree unit (or a prediction unit) is performed using the motion information 160 predicted or acquired from the encoded region according to such a mode, the motion information 160 of the coding tree unit (or the prediction unit) is stored as the reference motion information 166.

When encoding processing of an encoding target frame or slice is completed, the spatial direction reference motion information memory 601 holding the reference motion information 166 about the frame is changed in its handling to the temporal direction reference motion information memory 602 used for the frame on which encoding processing is performed next. At this point, the reference motion information 166 may be compressed and the compressed reference motion information 166 may be stored in the temporal direction reference motion information memory 602 to reduce the memory capacity of the temporal direction reference motion information memory 602. For example, the temporal direction reference motion information memory 602 can hold the reference motion information 166 in 16×16 pixel block units.

As illustrated in FIG. 1, the predicted motion information acquiring module 110 generates a motion information candidate 160A used by an encoding target prediction unit and the predicted motion information 167 used for differential encoding of motion information by the entropy encoder 113 with reference to the reference motion information 166 stored in the motion information memory 109. The predicted motion information acquiring module 110 will be described in detail later.

The motion detection module ill generates a motion vector by performing processing such as block matching between the prediction target block and the reference image signal 158 and outputs motion information including the generated motion vector as a motion information candidate 160B.

The motion information selection switch 112 selects one of the motion information candidate 160A output from the predicted motion information acquiring module 110 and the motion information candidate 160B output from the motion detection module 111 according to prediction information contained in the encoding control information 170 from the encoding controller 120. The motion information selection switch 112 outputs the selected motion information candidate to the inter-predictor 108, the motion information memory 109, and the entropy encoder 113 as the motion information 160.

Prediction information follows the prediction mode controlled by the encoding controller 120 and contains switching information to control the motion information selection switch 112 and information indicating which of the inter prediction and the intra prediction to apply to generate the predicted image signal 159. The encoding controller 120 determines which of the motion information candidate 160A and the motion information candidate 160B is optimum and generates switching information in accordance with the determination result. The encoding controller 120 also determines which of, among a plurality of prediction modes, the intra prediction and the inter prediction is the optimum prediction mode and generates selection information indicating the optimum prediction mode. For example, the encoding controller 120 determines the optimum prediction mode using a cost function shown in Formula (1) below:

K=SAD+λ×OH (1)

In Formula (1), OH represents the code amount related to prediction information (for example, motion vector information or predicted block size information) and SAD represents a sum of absolute values of differences between the prediction target block and the predicted image signal 159 (namely, a cumulative sum of absolute values of the prediction error signal 152). λ represents the Lagrange undetermined multiplier decided based on the value of quantization information (quantization parameter) and K represents an encoding cost.

When Formula (1) is used, the prediction mode that minimizes the encoding cost (also called a simplified encoding cost) K is determined to be the optimum prediction mode from the viewpoint of the generated code amount and prediction errors. However, the simplified encoding cost is not limited to the example of Formula (1) and may be estimated only from the code amount OH or the sum of absolute values of differences SAD or may be estimated by using the value obtained by applying a Hadamard transform to the sum of absolute values of differences SAD or an approximate value thereof.

Alternatively, the optimum prediction mode can be determined by using a temporary encoder (not illustrated). For example, the encoding controller 120 decides the optimum prediction mode using the cost function shown in Formula (2) below:

J=D+λ×R (2)

In Formula (2), D represents a sum of square errors between the prediction target block and locally-decoded images, that is, encoding distortion, R represents the code amount of prediction errors between the prediction target block and the predicted image signal 159 estimated based on temporary encoding, and J represents the encoding cost. When the encoding cost (also called a detailed encoding cost) J in Formula (2) is calculated, temporary encoding processing and locally-decoding processing are needed for each prediction mode, leading to an increased circuit scale and/or an increased amount of operation. On the other hand, the encoding cost J is calculated based on the more precise encoding distortion and code amount so that high encoding efficiency can be maintained by determining the optimum prediction mode with high precision.

However, the detailed encoding cost is not limited to the example of Formula (2) and may be estimated only from the code amount R or the encoding distortion D or may be estimated by using an approximate value of the code amount R or the encoding distortion D. Alternatively, these cost functions may hierarchically be used. For example, the encoding controller 120 can narrow down the number of prediction mode candidates in which a determination using Formula (1) or Formula (2) is made based on information about the prediction target block obtained in advance (for example, prediction modes of surrounding pixel blocks, image analysis results and the like).

As a modification of the present embodiment, the number of prediction mode candidates can further be reduced while encoding performance is maintained by making a two-stage mode determination combining Formula (1) and Formula (2). In contrast to Formula (2), the simplified encoding cost shown in Formula (1) does not need locally-decoding processing and can be operated at high speed. In the moving image encoding apparatus 100 according to the present embodiment in which the number of prediction modes is large when compared with even H.264, the mode determination using only the detailed encoding cost J could delay processing. Thus, in the first step, the encoding controller 120 calculates the simplified encoding cost K of prediction modes available for pixel blocks to select prediction mode candidates from among available prediction modes. In the second step, the encoding controller 120 calculates the detailed encoding cost J of prediction mode candidates to decide the prediction mode candidate that minimizes the detailed encoding cost J as the optimum prediction mode. The number of prediction mode candidates can be changed by using the property that the correlation between the simplified encoding cost and the detailed encoding cost increases with an increasing value of the quantization parameter that determines the roughness of quantization.

Next, the prediction processing of the moving image encoding apparatus 100 will be described below.

A plurality of prediction modes are provided for the moving image encoding apparatus 100 in FIG. 1 and the generation method of the predicted image signal 159 and the motion compensation block size are different from prediction mode to prediction mode. The method in which the inter-predictor 108 generates the predicted image signal 159 includes the method of generating a predicted image using the reference image signal 158 of one or more encoded reference frames (or reference fields).

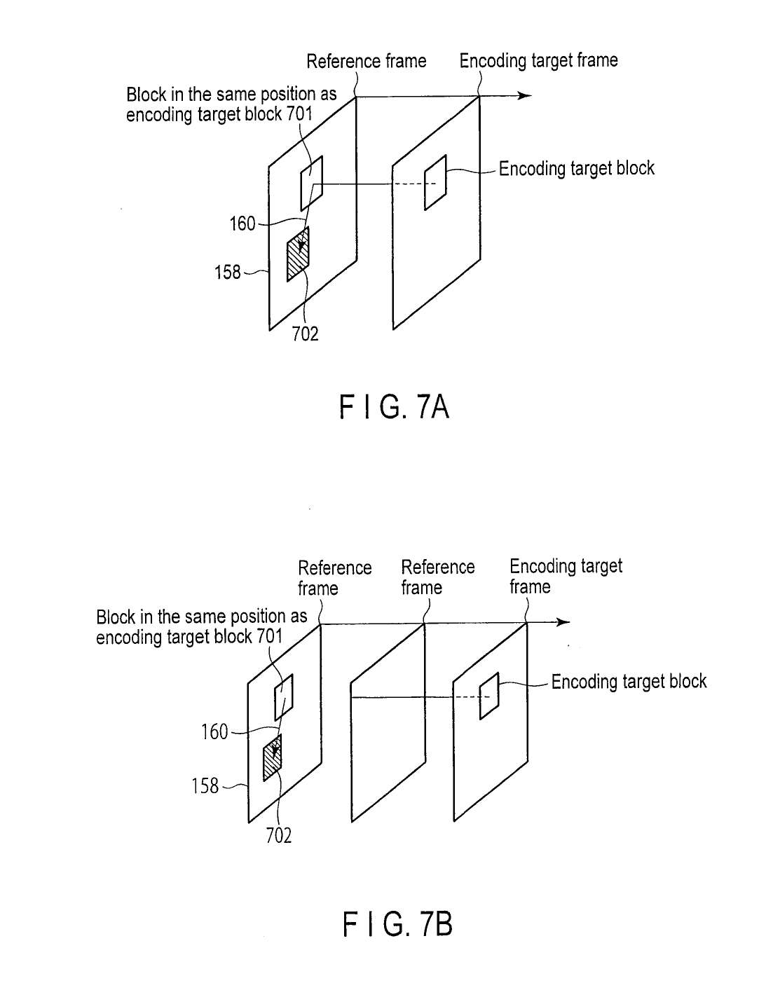

The inter prediction will be described using FIG. 7A. Typically, the inter prediction is performed in prediction units, and the motion information 160 can be different from prediction unit to prediction unit. In the inter prediction, as illustrated in FIG. 7A, the predicted image signal 159 is generated using the reference image signal 158 of a block 702 which is a pixel block in the encoded reference frame (for example, the encoded frame one frame earlier) and is in the position that is spatially shifted from a block 701 located in the same position as the encoding target prediction unit according to the motion vector included in the motion information 160. That is, the reference image signal 158 of the block in the reference frame, which is specified by the position (coordinates) of the encoding target block and the motion vector included in the motion information 160, is used in generating the predicted image signal 159.

In the inter prediction, motion compensation of decimal pixel accuracy (for example, ½ pixel accuracy or ¼ pixel accuracy) can be performed, and the value of an interpolation pixel is generated by performing filtering processing on the reference image signal 158. For example, in H.264, interpolation processing can be performed on a luminance signal up to the ¼ pixel accuracy. The interpolation processing may be performed by using any filtering other than filtering specified in H.264.

The inter prediction is not limited to the example in which the reference frame one frame earlier is used, as illustrated in FIG. 7A, and any reference frame having been encoded may be used. For example, as illustrated in FIG. 7B, the reference frame two frames earlier from the encoding target frame may be used. When the reference image signals 158 of a plurality of reference frames having different temporal positions are stored in the reference image memory 107, the information indicating from the reference image signal 158 of which temporal position the predicted image signal 159 is generated is represented by the reference frame number. The reference frame number is included in the motion information 160. The reference frame number can be changed in region units (such as picture units, slice units, and block units). That is, different reference frames can be used in each prediction unit. As an example, when the reference frame one encoded frame earlier is used in the prediction, the reference frame number in this region is set to 0. When the reference frame two encoded frames earlier is used in the prediction, the reference frame number in this region is set to 1. As another example, when the reference image signal 158 only for one frame is stored in the reference image memory 107 (the number of reference frames stored is one), the reference frame number is always set to 0.

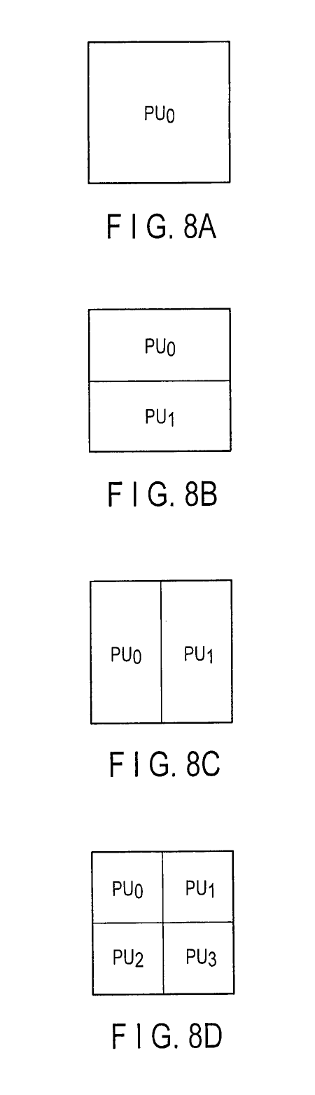

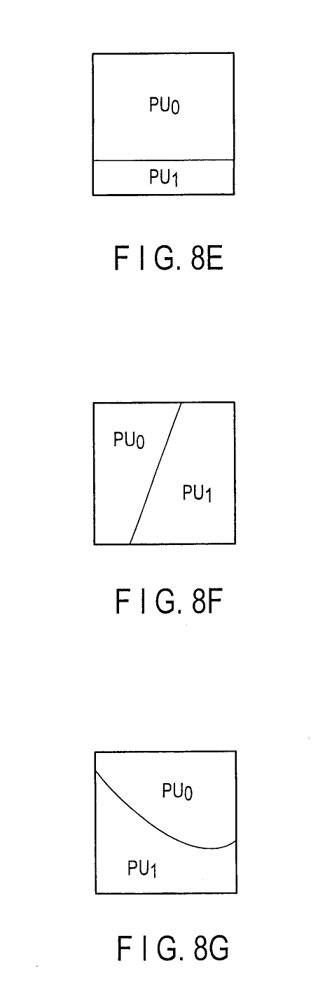

Further, in the inter prediction, the size suitable for the encoding target block can be selected from sizes of a plurality of prediction units prepared in advance. For example, as illustrated in FIGS. 8A to 8G, the motion compensation can be performed for each prediction unit obtained by dividing the coding tree unit. In FIGS. 8A to 8G, a block PUₓ (x=0, 1, 2, and 3) indicates a prediction unit. FIG. 8A illustrates an example in which the size of the prediction unit is equal to that of the coding tree unit. In this case, one prediction unit PU₀ exists in the coding tree unit.

FIGS. 8B to 8G illustrate examples in each of which a plurality of prediction units exist in the coding tree unit. In FIGS. 8B and 8C, two prediction units PU₀ and PU₁ exist in the coding tree unit. In FIG. 8B, the prediction units PU₀ and PU₁ are two blocks into which the coding tree unit is longitudinally divided. In FIG. 8C, the prediction units PU₀ and PU₁ are two blocks into which the coding tree unit is transversely divided. FIG. 8D illustrates an example in which the prediction units are the four blocks into which the coding tree unit is divided.

The block sizes of the prediction units existing in the coding tree unit may mutually be different as illustrated in FIG. 8E. The prediction units are not limited to examples of rectangular shapes and may be, as illustrated in FIGS. 8F and 8G, blocks of shapes obtained by dividing the coding tree unit by any line segment or any curve like an arc.

As described above, the motion information 160 of encoded pixel blocks (for example, a 4×4 pixel block) in the encoding target frame used for inter prediction is stored in the motion information memory 109 as the reference motion information 166. Accordingly, the optimum shape and motion vector and the reference frame number can be used according to the local properties of the input image signal 151. In addition, the coding tree unit and the prediction unit can arbitrarily be combined. As described above, when the coding tree unit is the 64×64-pixel block, pixel blocks from the 64×64-pixel block to the 16×16-pixel block can hierarchically be used by further dividing into four coding tree units each coding tree unit obtained by dividing the 64×64-pixel block into four coding tree units (32×32-pixel blocks). Similarly, pixel blocks from the 64×64-pixel block to the 8×8-pixel block can hierarchically be used. When the prediction unit is one obtained by dividing the coding tree unit into four, hierarchical motion compensation processing from the 64×64-pixel block to the 4×4-pixel block can be performed.

In the inter prediction, a bidirectional prediction using two kinds of motion compensation can be performed to the encoding target block. In the bidirectional prediction of H.264, two predicted image signals are generated by performing two kinds of motion compensation to the encoding target block and a new predicted image signal is obtained as a weighted average of the two predicted image signals. In the bidirectional prediction, two kinds of motion compensation are each called a list 0 prediction and a list 1 prediction.

Next, the skip mode, the merge mode, and the inter mode will be described.

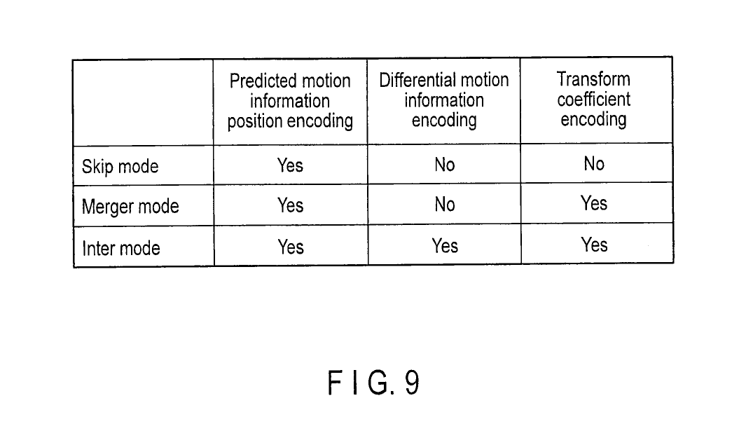

The moving image encoding apparatus 100 according to the present embodiment uses a plurality of different prediction modes illustrated in FIG. 9, in which encoding processing is different. As illustrated in FIG. 9, the skip mode is a mode in which a syntax related to the predicted motion information position is encoded and other syntaxes are not encoded. The merge mode is a mode in which the syntax related to the predicted motion information position and information about transform coefficients are encoded and other syntaxes are not encoded. The inter mode is a mode in which the syntax related to the predicted motion information position, differential motion information, and information about transform coefficients are encoded. These modes are switched by prediction information controlled by the encoding controller 120.

Next, the predicted motion information acquiring module 110 will be described.

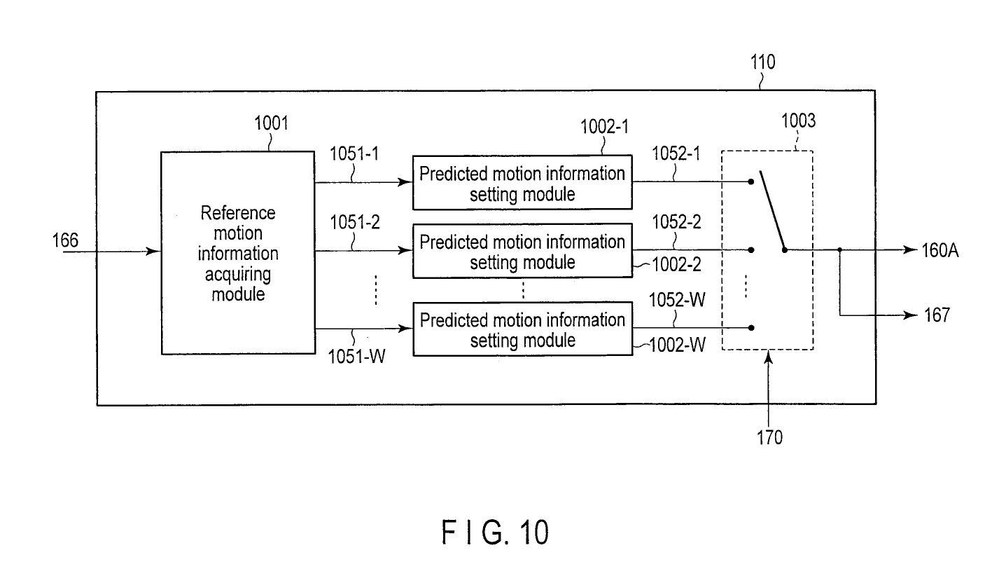

FIG. 10 illustrates the predicted motion information acquiring module 110 in more detail. The predicted motion information acquiring module 110 includes, as illustrated in FIG. 10, a reference motion information acquiring module 1001, motion information setting modules 1002-1 to 1002-W, and a predicted motion information selection switch 1003. W represents the number of predicted motion information candidates generated by the reference motion information acquiring module 1001.

The reference motion information acquiring module 1001 acquires the reference motion information 166 from the motion information memory 109. The reference motion information acquiring module 1001 uses the acquired reference motion information 166 to generate one or more predicted motion information candidates 1051-1, 1051-2, . . . , 1051-W. The predicted motion information candidates are also called predicted motion vector candidates.

The predicted motion information setting modules 1002-1 to 1002-W receive the predicted motion information candidates 1051-1 to 1051-W from the reference motion information acquiring module 1001 and generate corrected predicted motion information candidates 1052-1 to 1052-W respectively by setting the prediction method (the unidirectional prediction or the bidirectional prediction) applied to the encoding target prediction unit and the reference frame number and scaling motion vector information.

The predicted motion information selection switch 1003 selects a candidate from one or more corrected predicted motion information candidates 1052-1 to 1052-W according to an instruction contained in the encoding control information 170 from the encoding controller 120. Then, the predicted motion information selection switch 1003 outputs the selected candidate to the motion information selection switch 112 as the motion information candidate 160A and also outputs the predicted motion information 167 used for differential encoding of motion information by the entropy encoder 113. Typically, the motion information candidate 160A and the predicted motion information 167 contain the same motion information, but may contain mutually different motion information according to an instruction of the encoding controller 120. Instead of the encoding controller 120, the predicted motion information selection switch 1003 may output predicted motion information position information described later. The encoding controller 120 decides which of the corrected predicted motion information candidates 1052-1 to 1052-W to select by using an evaluation function like, for example, Formula (1) or Formula (2).

When the motion information candidate 160A is selected by the motion information selection switch 112 as the motion information 160 and stored in the motion information memory 109, the list 0 predicted motion information candidate retained by the motion information candidate 160A may be copied to the list 1 predicted motion information candidate. In this case, the reference motion information 166 containing list 0 predicted motion information and list 1 predicted motion information, which is the same information as the list 0 predicted motion information, is used by the predicted motion information acquiring module 110 as the reference motion information 166 of an adjacent prediction unit when the subsequent prediction unit is encoded.

When the predicted motion information setting modules 1002-1 to 1002-W, the predicted motion information candidates 1051-1 to 1051-W, and the corrected predicted motion information candidates 1052-1 to 1052-W are each described without being particularly distinguishing from one another, the number (“-1” to “W”) at the end of the reference numeral is omitted to simply refer to the predicted motion information setting module 1002, the predicted motion information candidates 1051, and the corrected predicted motion information candidates 1052.

Next, the method of generating the predicted motion information candidates 1051 by the reference motion information acquiring module 1001 will concretely be described.

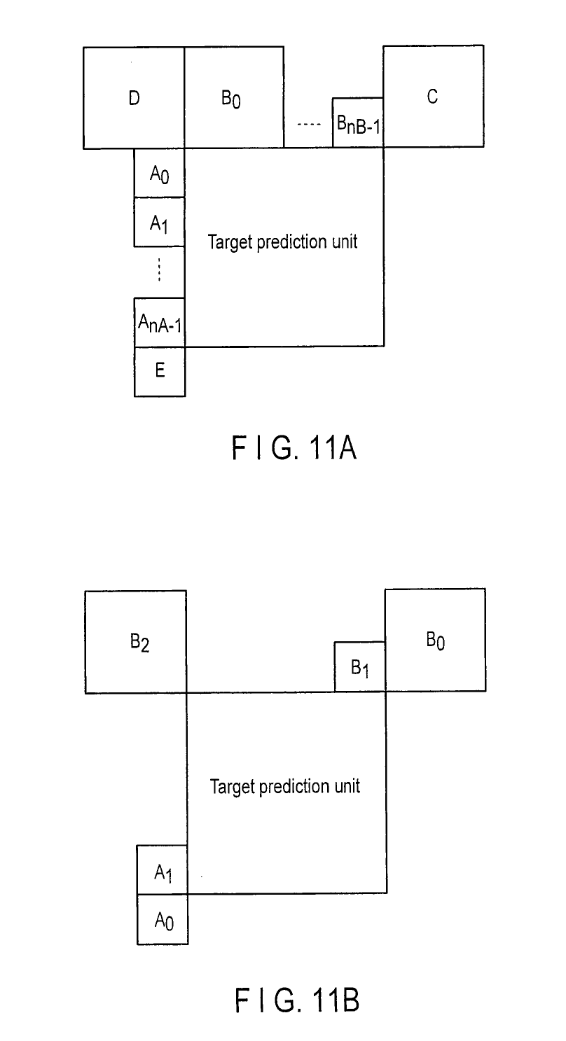

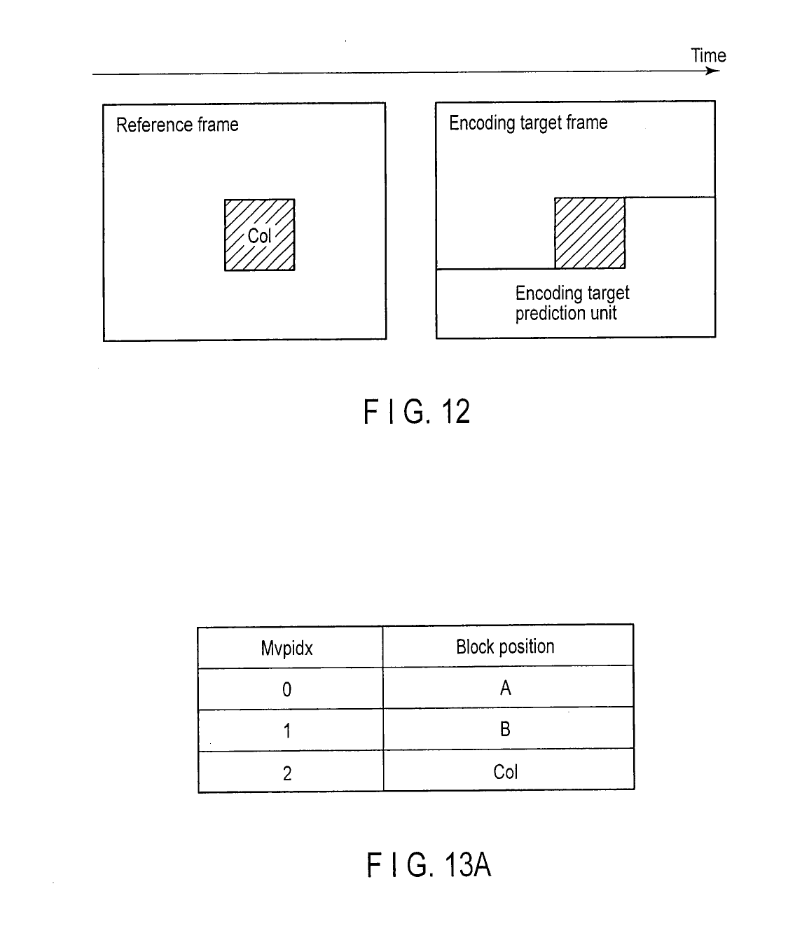

FIGS. 11A, 11B, and 12 each show examples of positions of adjacent prediction units referred to by the reference motion information acquiring module 1001 to generate the predicted motion information candidates 1051. FIG. 11A illustrates an example of setting prediction units spatially adjacent to the encoding target prediction unit to adjacent prediction units. Blocks A_{X} (X=0, 1, . . . , nA−1) show prediction units adjacent to the left side of the encoding target prediction unit. Blocks B_{Y} (Y=0, 1, . . . , nB−1) show prediction units adjacent to the upper side of the encoding target prediction unit. Blocks C, D, E show blocks adjacent to the upper right, the upper left, and the lower left of the encoding target prediction unit respectively.

FIG. 11B illustrates another example of setting prediction units spatially adjacent to the encoding target prediction unit to adjacent prediction units. In FIG. 11B, adjacent prediction units A₀, A₁ are positioned on the lower left and on the left of the encoding target prediction unit respectively. Further, adjacent prediction units B₀, B₁, B₂ are positioned on the upper right, the upper side, and the upper left of the encoding target prediction unit respectively.

FIG. 12 illustrates an example of setting prediction units (prediction units in an encoded reference frame) temporally adjacent to the encoding target prediction unit to adjacent prediction units. An adjacent prediction unit illustrated in FIG. 12 is a prediction unit in a reference frame positioned at the same coordinates as those of the encoding target prediction unit. The position of this adjacent prediction unit is denoted as a position Col.

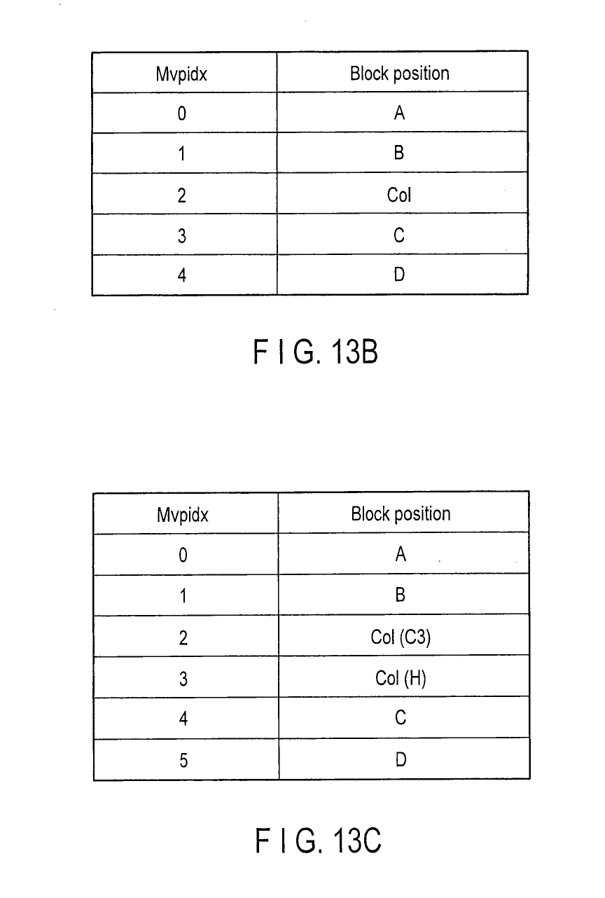

FIG. 13A illustrates an example of a list showing a relationship between the block position referred to by the reference motion information acquiring module 1001 to generate the predicted motion vector candidates 1051 and a block position index Mvpidx. A block position A is set to, for example, as illustrated in FIG. 11A, the position of one of the adjacent prediction units A_{X} (X=0, 1, . . . , nA-1) positioned in the spatial direction. As an example, adjacent prediction units to which an inter prediction is applied, that is, adjacent prediction units having the reference motion information 166 are selected from the adjacent prediction units A_{X} (X=0, 1, . . . , nA−1) and the position of the adjacent prediction unit having the smallest value of X among the selected adjacent prediction units is decided as the block position A. The predicted motion vector candidate 1051 whose block position index Mvpidx is 0 is generated from reference motion information of an adjacent prediction unit of the block position A positioned in the spatial direction.

A block position B is set to, for example, as illustrated in FIG. 11A, the position of one of the adjacent prediction units B_{Y} (Y=0, 1, . . . , nB−1) positioned in the spatial direction. For example, adjacent prediction units to which an inter prediction is applied, that is, adjacent prediction units having the reference motion information 166 are selected from the adjacent prediction units B_{Y} (Y=0, 1, . . . , nB−1) and the position of the adjacent prediction unit having the smallest value of Y among the selected adjacent prediction units is decided as the block position B. The predicted motion vector candidate 1051 whose block position index Mvpidx is 1 is generated from reference motion information of an adjacent prediction unit of the block position B positioned in the spatial direction.

Further, the predicted motion vector candidate 1051 whose block position index Mvpidx is 2 is generated from the reference motion information 166 of an adjacent prediction unit of the position Col in the reference frame.

When predicted motion vector candidates are generated by the reference motion information acquiring module 1001 according to the list in FIG. 13A, three predicted motion vector candidates are generated. In this case, the predicted motion vector candidate whose index Mvpidx is 0 corresponds to the predicted motion vector candidate 1051-1 illustrated in FIG. 10. Further, the predicted motion vector candidate whose index Mvpidx is 1 corresponds to the predicted motion vector candidate 1051-2 and the predicted motion vector candidate whose index Mvpidx is 3 corresponds to the predicted motion vector candidate 1051-3.

FIG. 13B illustrates another example of the list showing the relationship between the block position referred to by the reference motion information acquiring module 1001 to generate the predicted motion vector candidates 1051 and the block position index Mvpidx. When predicted motion vector candidates are generated by the reference motion information acquiring module 1001 according to the list in FIG. 13B, five predicted motion vector candidates are generated. Block positions C, D indicate, for example, the positions of the adjacent prediction units C, D illustrated in FIG. 11A. If an inter prediction is not applied to an adjacent prediction unit of the block position C, the reference motion information 166 of an adjacent prediction unit of the block position D is replaced by the reference motion information 166 of the adjacent prediction unit of the block position C. If an inter prediction is not applied to adjacent prediction units of the block positions C, D, the reference motion information 166 of an adjacent prediction unit of the block position E is replaced by the reference motion information 166 of the prediction unit position C.

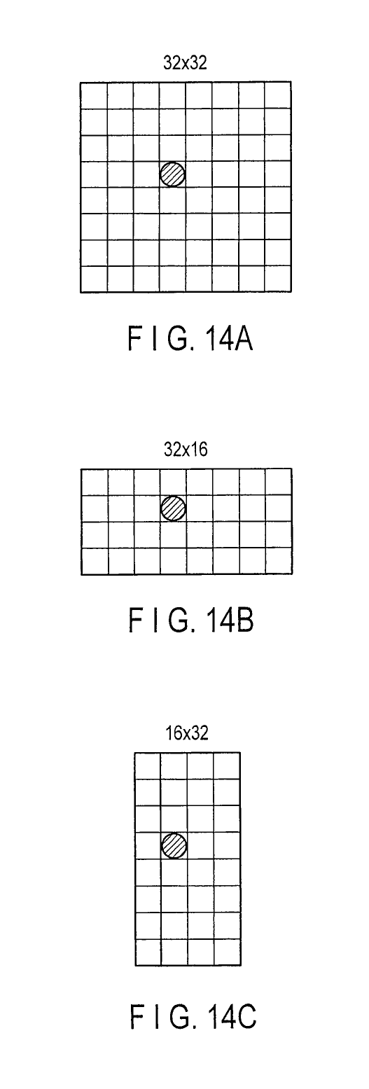

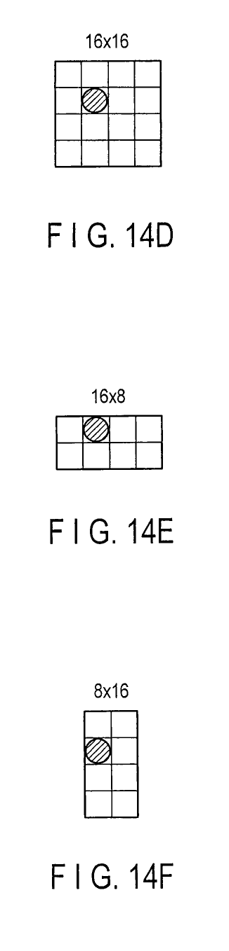

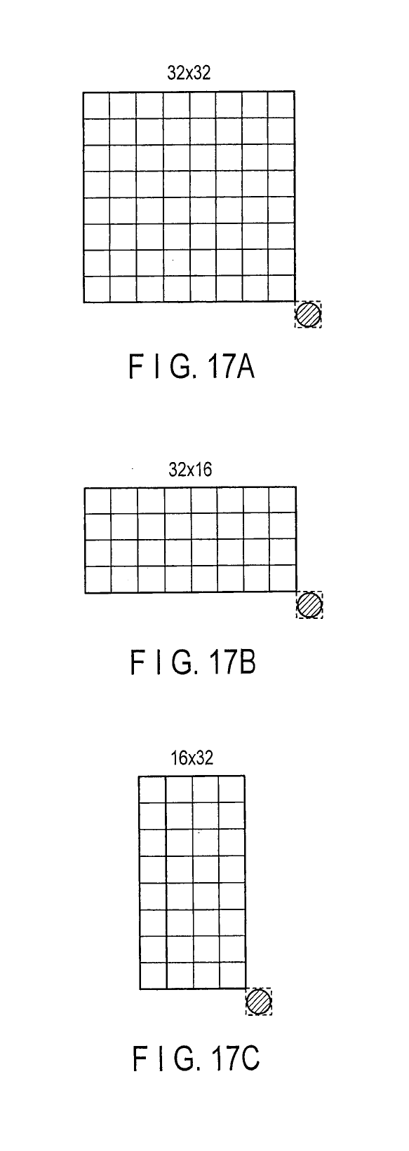

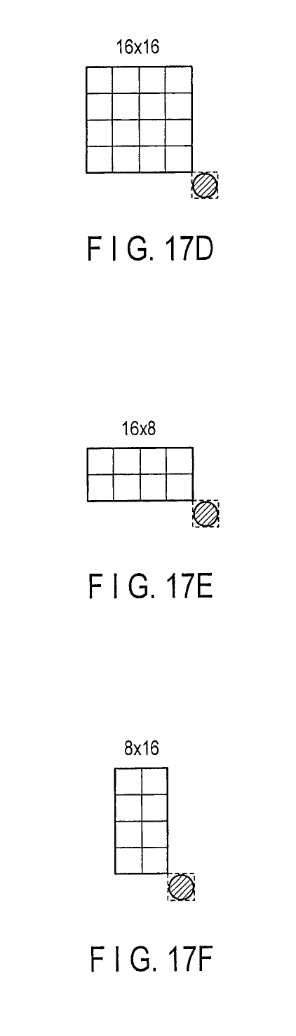

Further, as illustrated in FIG. 13C, a plurality of predicted motion information candidates may be generated from a plurality of adjacent prediction units positioned in the temporal direction. The block position Col (C3) illustrated in FIG. 13C shows, as will be described later by referring to FIGS. 14A to 16F, the position of a prediction unit in a predetermined position inside an adjacent prediction unit of the block position Col. The block position Col (H) illustrated in FIG. 13C shows, as will be described later by referring to FIGS. 17A to 17F, the position of a prediction unit in a predetermined position outside an adjacent prediction unit of the block position Col.

If the size of the encoding target prediction unit is larger than the size of the minimum prediction unit (for example, 4×4 pixels), an adjacent prediction unit of the block position Col may retain a plurality of pieces of the reference motion information 166 in the temporal direction reference motion information memory 602. In this case, the reference motion information acquiring module 1001 acquires one piece of the reference motion information 166 from the plurality of pieces of the reference motion information 166 retained in the adjacent prediction unit of the block position Col. In the present embodiment, the acquisition position of reference motion information in an adjacent prediction unit of the block position Col is called a reference motion information acquisition position.

FIGS. 14A to 14F illustrate examples in which the reference motion information acquisition position is set close to the center of an adjacent prediction unit of the position Col. FIGS. 14A to 14F correspond to cases in which the encoding target prediction unit is a 32×32-pixel block, a 32×16-pixel block, a 16×32-pixel block, a 16×16-pixel block, a 16×8-pixel block, and an 8×16-pixel block respectively. In FIGS. 14A to 14F, each block indicates a 4×4 prediction unit and a circle indicates a reference motion information acquisition position. In the examples of FIGS. 14A to 14F, the reference motion information 166 of the intra prediction unit indicated by a circle is used as a position predicted motion information candidate.

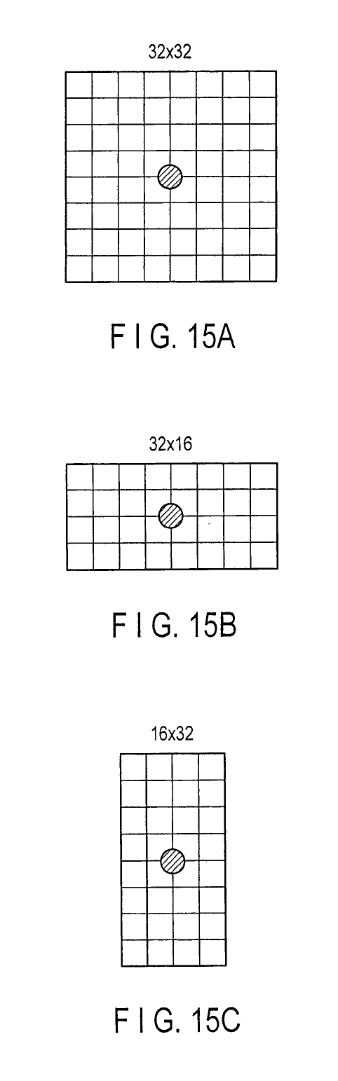

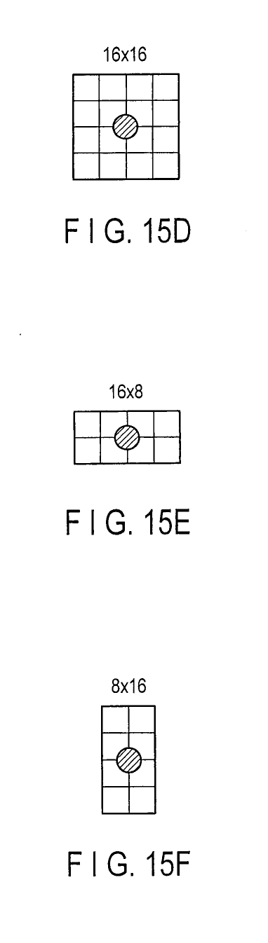

FIGS. 15A to 15F illustrate examples in which the reference motion information acquisition position is set to the center of an adjacent prediction unit of the position Col. FIGS. 15A to 15F correspond to cases in which the encoding target prediction unit is a 32×32-pixel block, a 32×16-pixel block, a 16×32-pixel block, a 16×16-pixel block, a 16×8-pixel block, and an 8×16-pixel block respectively. In FIGS. 15A to 15F, no 4×4 prediction unit exists in the reference motion information acquisition position indicated by a circle and so the reference motion information acquiring module 1001 generates the predicted motion information candidates 1051 according to a predetermined method. As an example, the reference motion information acquiring module 1001 calculates an average value or a median value of reference motion information of four 4×4 prediction units adjacent to the reference motion information acquisition position and generates the calculated average value or median value as the predicted motion information candidates 1051.

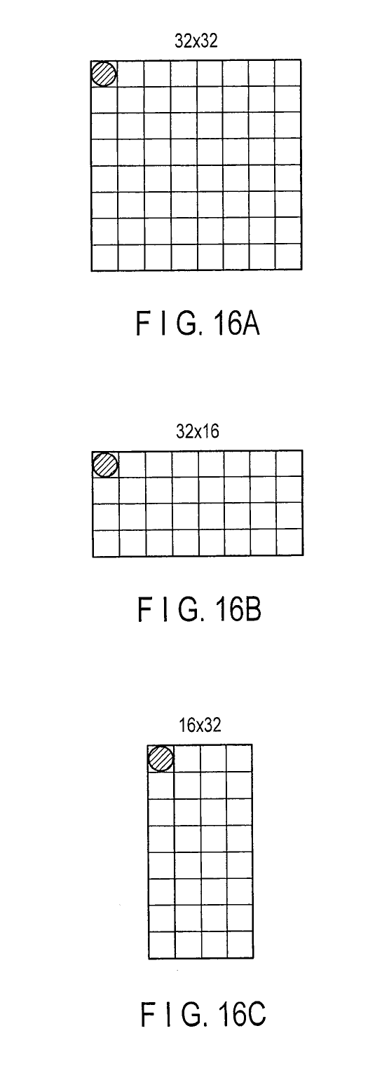

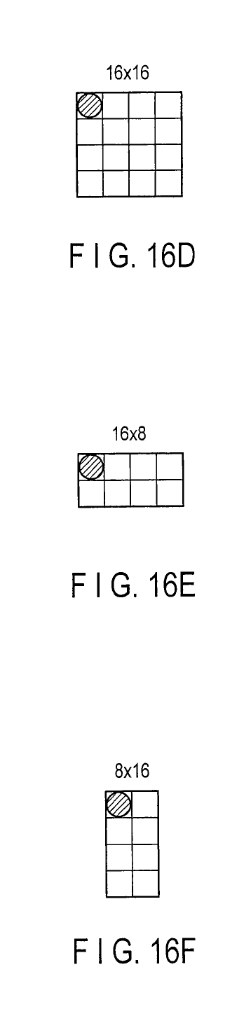

FIGS. 16A to 16F illustrate examples in which the reference motion information acquisition position is set to the upper left end of an adjacent prediction unit of the position Col. FIGS. 16A to 16F correspond to cases in which the encoding target prediction unit is a 32×32-pixel block, a 32×16-pixel block, a 16×32-pixel block, a 16×16-pixel block, a 16×8-pixel block, and an 8×16-pixel block respectively. In FIGS. 16A to 16F, reference motion information of a 4×4 prediction unit positioned on the upper left end of an adjacent prediction unit of the block position Col is used as a predicted motion information candidate.

The method of generating the predicted motion information candidates 1051 by referring to prediction units inside a reference frame is not limited to the method illustrated in FIGS. 14A to 16F and any method that is determined in advance may be followed. For example, as illustrated in FIGS. 17A to 17F, a position outside an adjacent prediction unit of the block position Col may be set as the reference motion information acquisition position. FIGS. 17A to 17F correspond to cases in which the encoding target prediction unit is a 32×32-pixel block, a 32×16-pixel block, a 16×32-pixel block, a 16×16-pixel block, a 16×8-pixel block, and an 8×16-pixel block respectively. In FIGS. 17A to 17F, the reference motion information acquisition position indicated by a circle is set to the position of the 4×4 prediction unit circumscribing the lower right of an adjacent prediction unit of the block position Col. If the 4×4 prediction unit cannot be referred to because the unit is outside the frame, an inter prediction is not applied to the unit or the like; instead, a prediction unit in the reference motion information acquisition position illustrated in FIGS. 14A to 16F may be referred to.

If the adjacent prediction unit does not have the reference motion information 166, the reference motion information acquiring module 1001 generates reference motion information having a zero vector as the predicted motion information candidates 1051.

In this manner, the reference motion information acquiring module (also called a predicted motion information candidate generator) 1001 generates one or more predicted motion information candidates 1051-1 to 1051-W by referring to the motion information memory 109. Adjacent prediction units referred to for the generation of predicted motion information candidates, that is, adjacent prediction units from which predicted motion information candidates are acquired or output are called reference motion blocks. When a unidirectional prediction is applied to the reference motion block, the predicted motion information candidates 1051 contain one of list 0 predicted motion information candidates used for a list 0 prediction and list 1 predicted motion information candidates used for a list 1 prediction. When a bidirectional prediction is applied to the reference motion block, the predicted motion information candidates 1051 contain both of list 0 predicted motion information candidates and list 1 predicted motion information candidates.

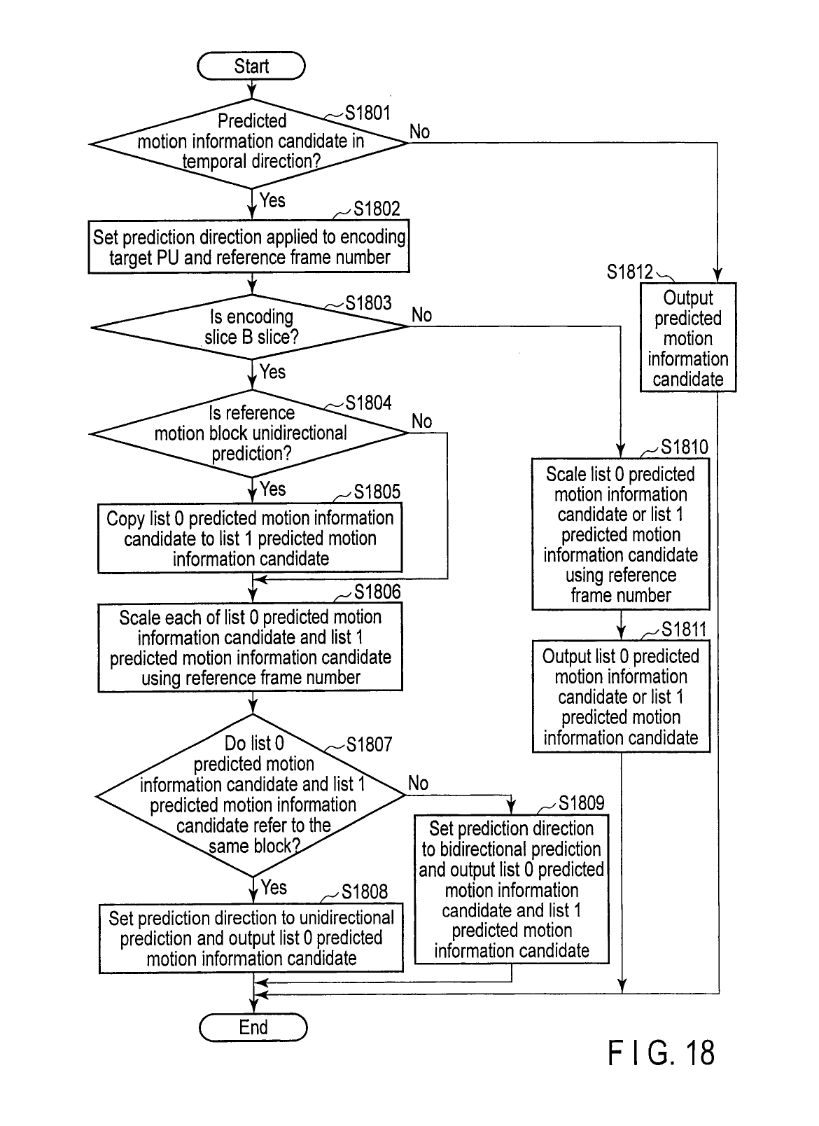

FIG. 18 illustrates an example of processing of the predicted motion information setting module 1002. As illustrated in FIG. 18, the predicted motion information setting module 1002 first determines whether the predicted motion information candidate 1051 has been output from a reference motion block in the spatial direction or a reference motion block in the temporal direction (step S1801). If the predicted motion information candidate 1051 has been output from a reference motion block in the spatial direction (the determination in step S1801 is NO), the predicted motion information setting module 1002 outputs the predicted motion information candidate 1051 as the corrected predicted motion information candidate 1052 (step S1812).

On the other hand, if the predicted motion information candidate 1051 has been output from a reference motion block in the temporal direction (the determination in step S1801 is YES), the predicted motion information setting module 1002 sets the prediction direction to be applied to the encoding target prediction unit and the reference frame number (step S1802). More specifically, if the encoding target prediction unit is a pixel block in a P slice to which only the unidirectional prediction is applied, the prediction direction is set to the unidirectional prediction. Further, if the encoding target prediction unit is a pixel block in a B slice to which the unidirectional prediction and the bidirectional prediction can be applied, the prediction direction is set to the bidirectional prediction. The reference frame number is set by referring to encoded adjacent prediction units positioned in the spatial direction.

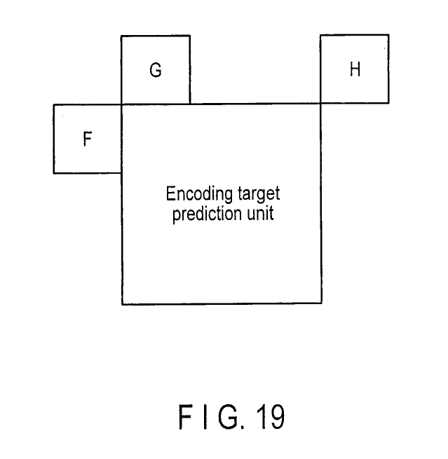

FIG. 19 illustrates the positions of adjacent prediction units used to set the reference frame number. As illustrated in FIG. 19, adjacent prediction units F, G, H are encoded prediction units adjacent to the left, the upper side, and the upper right of the encoding target prediction unit. The reference frame number is decided by a majority vote using the reference frame numbers of the adjacent prediction units F, G, H. As described above, the reference frame number is contained in reference motion information. As an example, if the reference frame numbers of the adjacent prediction units F, G, H are 0, 1, 1 respectively, the reference frame number of the encoding target prediction unit is decided in favor of 1.

If the reference frame numbers of the adjacent prediction units F, G, H are all different, the reference frame number of the encoding target prediction unit is set to the smallest reference frame number of these reference frame numbers. Further, if no inter prediction is applied to the adjacent prediction units F, G, H or the adjacent prediction units F, G, H cannot be referred to because the adjacent prediction units F, G, H are positioned outside a frame or a slice, the reference frame number of the encoding target prediction unit is set to 0. In other embodiments, the reference frame number of the encoding target prediction unit may be set by using one of the adjacent prediction units F, G, H or may be set to a fixed value (for example, 0). The processing in step S1802 is performed on a list 0 prediction when the slice to which the encoding target prediction unit belongs is a P slice and on both of a list 0 prediction and a list 1 prediction when the slice is a B slice.

Next, the predicted motion information setting module 1002 determines whether the slice (also called an encoding slice) to which the encoding target prediction unit belongs is a B slice (step S1803). If the encoding slice is not a B slice, that is, the encoding slice is a P slice (the determination in step S1803 is NO), the predicted motion information candidates 1051 contain one of the list 0 predicted motion information candidates and the list 1 predicted motion information candidates. In this case, the predicted motion information setting module 1002 scales a motion vector contained in the list 0 predicted motion information candidate or the list 1 predicted motion information candidate using the reference frame number set in step S1802 (step S1810). Further, the predicted motion information setting module 1002 outputs the list 0 predicted motion information candidate or the list 1 predicted motion information candidate containing the scaled motion vector as the corrected predicted motion information candidate 1052 (step S1811).

If the encoding slice is a B slice (the determination in step S1803 is YES), the predicted motion information setting module 1002 determines whether the unidirectional prediction is applied to the reference motion block (step S1804). If the unidirectional prediction is applied to the reference motion block (the determination in step S1804 is YES), the list 1 predicted motion information candidate does not exist in the predicted motion information candidates 1051 and thus, the predicted motion information setting module 1002 copies the list 0 predicted motion information candidates to the list 1 predicted motion information candidates (step S1805). If the bidirectional prediction is applied to the reference motion block (the determination in step S1804 is NO), the processing proceeds to step S1806 by skipping step S1805.

Next, the predicted motion information setting module 1002 scales a motion vector of the list 0 predicted motion information candidate and a motion vector of the list 1 predicted motion information candidate using the reference frame number set in step S1802 (step S1806). Next, the predicted motion information setting module 1002 determines whether the block referred to by the list 0 predicted motion information candidate and the block referred to by the list 1 predicted motion information candidate are the same (step S1807).

If the block referred to by the list 0 predicted motion information candidates and the block referred to by the list 1 predicted motion information candidates are the same (the determination in step S1807 is YES), a predicted value (predicted image) generated by the bidirectional prediction is equivalent to a predicted value (predicted image) generated by the unidirectional prediction. Thus, the predicted motion information setting module 1002 changes the prediction direction from the bidirectional prediction to the unidirectional prediction and outputs the corrected predicted motion information candidate 1052 containing only the list 0 predicted motion information candidate (step S1808). Thus, if the block referred to by the list 0 predicted motion information candidates and the block referred to by the list 1 predicted motion information candidates are the same, motion compensation processing and averaging processing in an inter prediction can be reduced by changing the prediction direction from the bidirectional prediction to the unidirectional prediction.

If the block referred to by the list 0 predicted motion information candidates and the block referred to by the list 1 predicted motion information candidates are not the same (the determination in step S1807 is NO), the predicted motion information setting module 1002 sets the prediction direction to the bidirectional prediction and outputs the corrected predicted motion information candidates 1052 containing the list 0 predicted motion information candidates and the list 1 predicted motion information candidates (step S1809).

In this manner, the predicted motion information setting module 1002 generates the corrected predicted motion information candidates 1052 by correcting the predicted motion information candidates 1051.

According to the present embodiment, as described above, motion information of the encoding target prediction unit is set by using motion information of encoded pixel blocks to perform an inter prediction and if the block referred to by motion information in the list 0 prediction and the block referred to by motion information in the list 1 prediction are the same, the prediction direction is set to the unidirectional prediction. Therefore, motion compensation processing and averaging processing in an inter prediction can be reduced. As a result, the amount of processing in an inter prediction can be reduced.

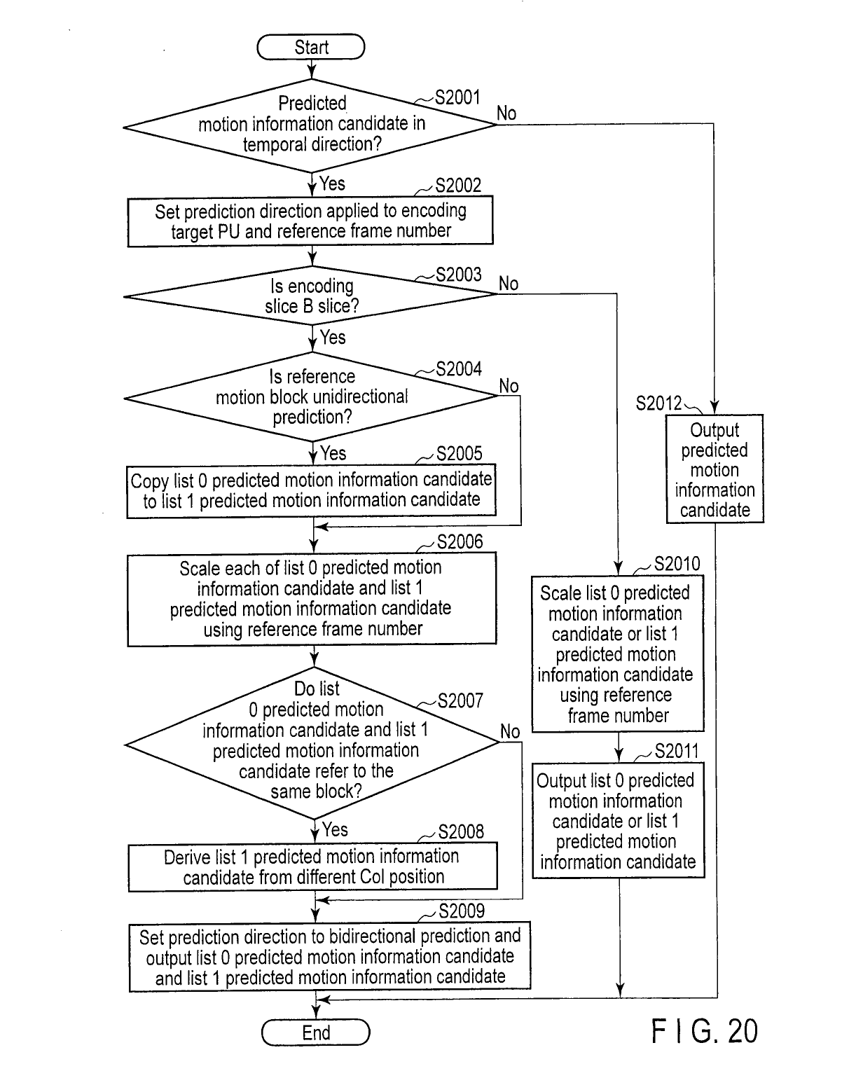

Next, another embodiment of processing of the predicted motion information setting module 1002 will be described by using the flow chart in FIG. 20. Steps S2001 to S2006 and S2010 to S2012 in FIG. 20 are the same as steps S1801 to S1806 and S1810 to S1812 illustrated in FIG. 18 and thus, the description thereof is omitted.

In step S2007, the predicted motion information setting module 1002 determines whether the block referred to by the list 0 predicted motion information candidate and the block referred to by the list 1 predicted motion information candidate, which are generated in steps S2001 to S2006, are the same. If the block referred to by the list 0 predicted motion information candidates and the block referred to by the list 1 predicted motion information candidates are the same (the determination in step S2007 is YES), a predicted value (predicted image) generated by the bidirectional prediction is equivalent to a predicted value (predicted image) generated by the unidirectional prediction. Thus, the predicted motion information setting module 1002 derives list 1 predicted motion information candidate again from a position spatially different from the reference motion information acquisition position from which the list 1 predicted motion information candidate has been derived (step S2008). Hereinafter, the reference motion information acquisition position used when the processing illustrated in FIG. 20 is started is called a first reference motion information acquisition position and the reference motion information acquisition position used to derive reference motion information again in step S2008 is called a second reference motion information acquisition position.

Typically, the first reference motion information acquisition position is set to, as indicated by a circle in FIG. 17A, a position circumscribing the lower right of the prediction unit in the position Col in a reference frame and the second reference motion information acquisition position is set to, as indicated by a circle in FIG. 14A, a predetermined position inside the prediction unit in the position Col inside the same reference frame. Alternatively, the first reference motion information acquisition position and the second reference motion information acquisition position may be set to positions illustrated in FIGS. 14A to 16F or other positions that are not illustrated.

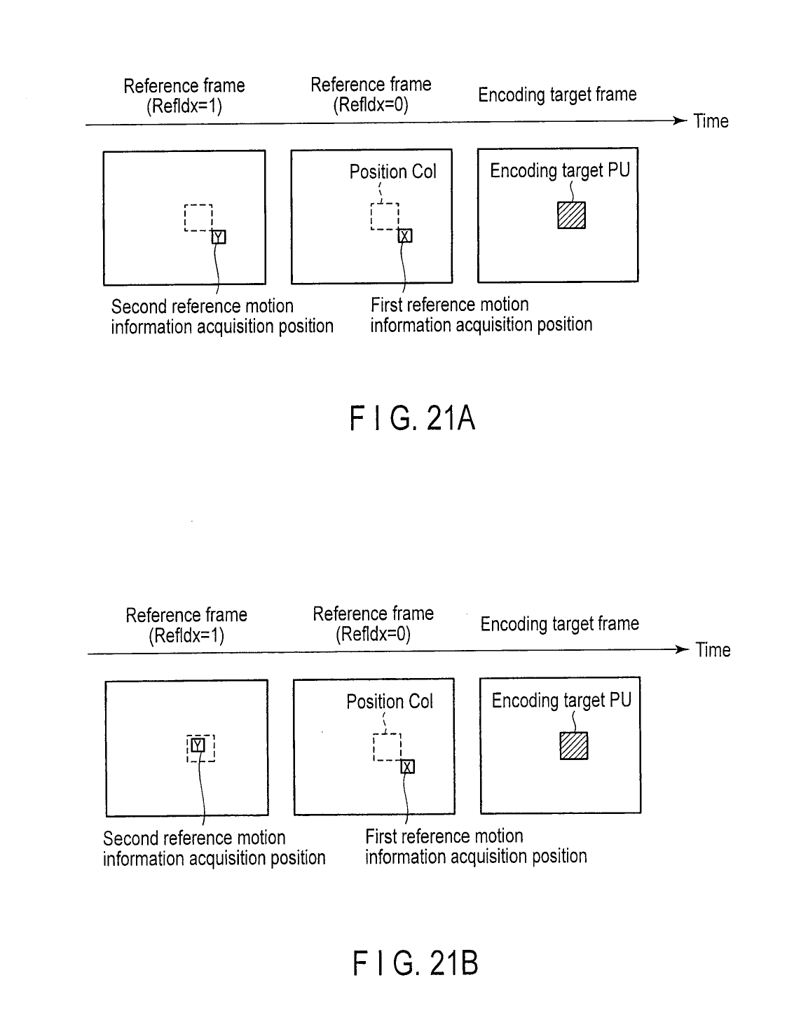

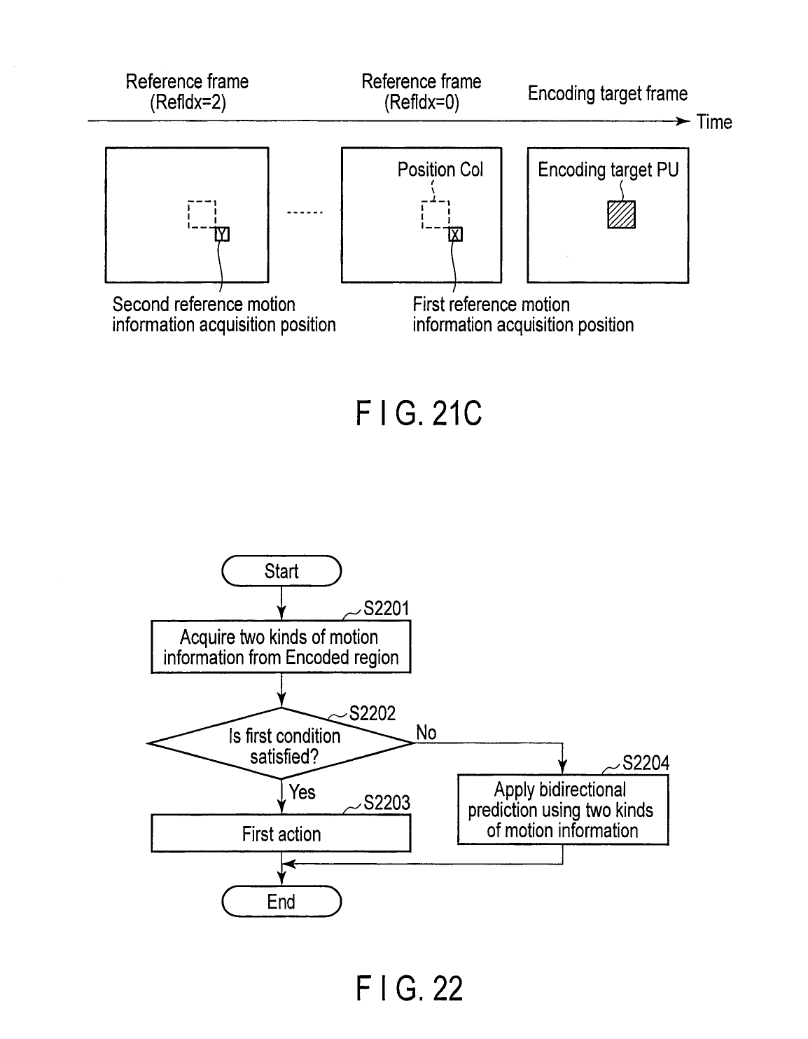

Further, the first reference motion information acquisition position and the second reference motion information acquisition position may be positioned in reference frames that are mutually temporally different. FIG. 21A illustrates an example in which the first reference motion information acquisition position and the second reference motion information acquisition position are positioned in temporally different reference frames. As illustrated in FIG. 21A, the first reference motion information acquisition position is set to a position X on the lower right of the prediction unit in the position Col inside the reference frame whose reference frame number (RefIdx) is 0. Further, the second reference motion information acquisition position Y is set to a position inside the reference frame whose reference frame number is 1, which is the same position as the first reference motion information acquisition position X. As illustrated in FIG. 21B, the first reference motion information acquisition position and the second reference motion information acquisition position may be set to spacio-temporally different positions. In FIG. 21B, the second reference motion information acquisition position Y is set to a position inside the reference frame whose reference frame number is 1, which is a predetermined position inside the prediction unit positioned at the same coordinates as those of the encoding target prediction unit. Further, as illustrated in FIG. 21C, the position of the reference frame to which the first reference motion information acquisition position belongs and the position of the reference frame to which the second reference motion information acquisition position belongs may be any temporal position. In FIG. 21C, the first reference motion information acquisition position X is set to a position on the reference frame whose reference frame number is 0 and the second reference motion information acquisition position Y is set to a position inside the reference frame whose reference frame number is 2, which is the same position as the first reference motion information acquisition position X.

According to the this embodiment, as described above, motion information of the encoding target prediction unit is set by using motion information of encoded pixel blocks to perform an inter prediction and if the block referred to by motion information in the list 0 prediction and the block referred to by motion information in the list 1 prediction are the same, motion information in the list 1 prediction is acquired by a method different from an acquisition method of motion information in the list 0 prediction. Therefore, a bidirectional prediction whose prediction efficiency is higher than that of the unidirectional prediction can be realized. Two kinds of motion information suitable for bidirectional prediction can be acquired by setting the acquisition position of motion information in the list 1 prediction to a closer position in accordance with the conventional acquisition position, which leads to further improvement of prediction efficiency.

Next, still another embodiment of processing of the predicted motion information setting module 1002 will be described by using the flow chart in FIG. 22. As illustrated in FIG. 22, the predicted motion information setting module 1002 acquires two kinds of motion information (the first predicted motion information and the second predicted motion information) from an encoded region (step S2201). For example, two kinds of motion information can be acquired from the aforementioned reference motion information acquisition positions. As a method of acquiring two kinds of motion information, motion information with high frequency may be used by calculating the frequency of motion information adapted to the encoding target prediction unit in advance or predetermined motion information may be used.

Next, the predicted motion information setting module 1002 determines whether the two kinds of motion information acquired in step S2201 satisfy a first condition (step S2202). The first condition includes at least one of conditions (A) to (F) shown below:

(A) Two kinds of motion information refer to the same reference frame;

(B) Two kinds of motion information refer to the same reference block;

(C) Reference frame numbers contained in two kinds of motion information are the same;

(D) Motion vectors contained in two kinds of motion information are the same;

(E) The absolute value of a difference between motion vectors contained in two kinds of motion information is equal to a predetermined threshold or less; and

(F) The numbers of reference frames and the configurations used for a list 0 prediction and a list 1 prediction are the same.

If, in step S2202, at least one of the conditions (A) to (F) is satisfied, two kinds of motion information are determined to satisfy the first condition. Alternatively, the first condition may always be determined to be satisfied. The same first condition as that set to a moving image decoding apparatus that will be described in the second embodiment is set to the moving image encoding apparatus 100. Alternatively, the first condition to be set to the moving image encoding apparatus 100 may be transmitted to the moving image decoding apparatus as additional information.

If the first condition is not satisfied (the determination in step S2202 is NO), a bidirectional prediction is applied to the encoding target prediction unit without changing two kinds of motion information (step S2104). If the first condition is satisfied (the determination in step S2202 is YES), the predicted motion information setting module 1002 performs a first action (step S2203). The first action includes one or more of actions (1) to (6) shown below:

(1) Set the prediction method to the unidirectional prediction and output one of two kinds of motion information as a list 0 predicted motion information candidate;

(2) Set the prediction method to the bidirectional prediction and acquire motion information from a block position spatially different from the acquisition position of motion information to output two kinds of motion information as a list 0 predicted motion information candidate and a list 1 predicted motion information candidate;

(3) Set the prediction method to the bidirectional prediction and acquire motion information from a block position temporally different from the acquisition position of motion information to output two kinds of motion information as a list 0 predicted motion information candidate and a list 1 predicted motion information candidate;

(4) Set the prediction method to the bidirectional prediction and change the reference frame number contained in motion information to output two kinds of motion information as a list 0 predicted motion information candidate and a list 1 predicted motion information candidate; and

(5) Set the prediction method to the bidirectional prediction and change a motion vector contained in motion information to output two kinds of motion information as a list 0 predicted motion information candidate and a list 1 predicted motion information candidate.

The actions (2) to (5) may be applied to only one of two kinds of motion information or both kinds of motion information. Typically, in the action (4), instead of the reference frame from which original motion information is acquired, the reference frame closest to the encoding target frame is applied. Typically, in the action (5), a motion vector obtained by shifting a motion vector by a fixed value is applied.

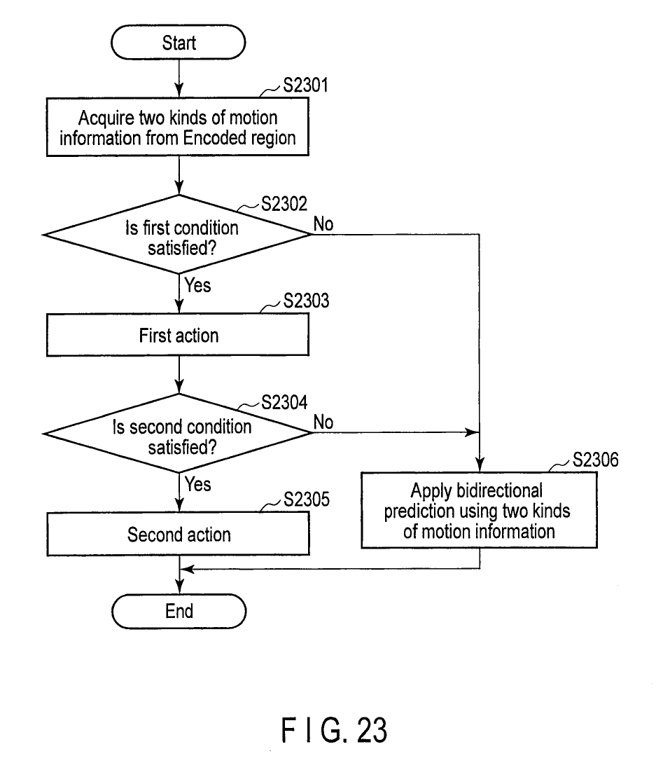

Next, still another embodiment of processing of the predicted motion information setting module 1002 will be described by using the flow chart in FIG. 23. Steps S2301 to S2303 and S2306 in FIG. 23 are the same as steps S2201 to S2203 and S2204 in FIG. 22 respectively. The description of these steps is omitted. The flow chart in FIG. 23 is different from that in FIG. 22 in that the determination of a second condition (step S2304) and a second action (step S2305) are added after the first action shown in step S2303. As an example, a case when the condition (B) is used as the first condition and the second condition and also the action (2) is used as the first action and the action (1) is used as the second action will be described.

In the action (2), motion information is acquired from a spatially different block position. Thus, if the motion information does not change spatially, the motion information is the same before and after the first action. If the motion information is the same before and after the first action as described above, the amount of processing of motion compensation is reduced by setting the prediction direction to the unidirectional prediction by applying the second action (step S2305). Therefore, the present embodiment can improve prediction efficiency of the bidirectional prediction and also reduce the amount of processing of motion compensation when motion information does not change spatially. As a result, an encoding efficiency can be improved.

Next, a case when a weighted prediction shown in H.264 is applied will be described by taking processing of the predicted motion information setting module 1002 illustrated in FIG. 22 as an example.

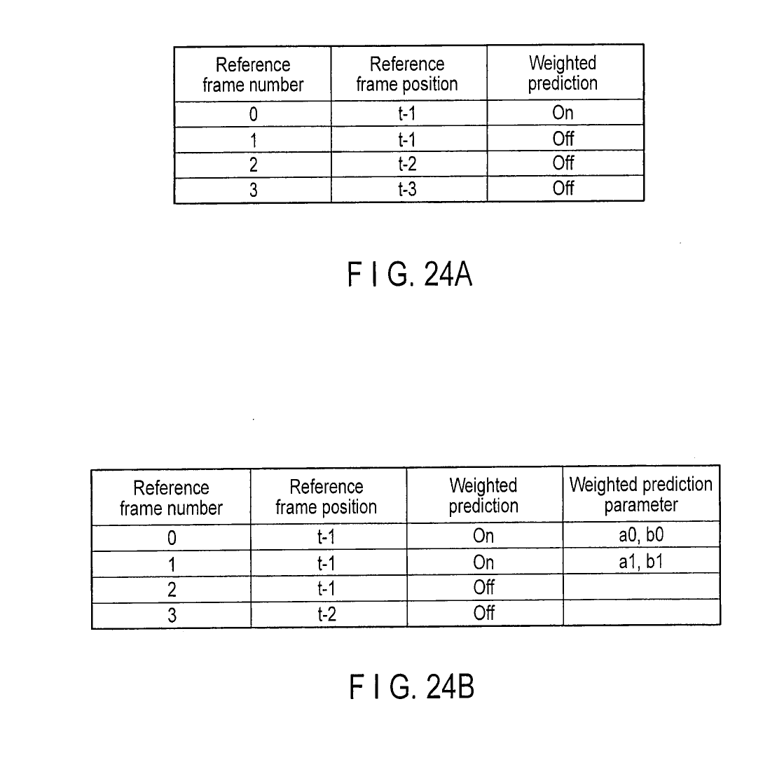

FIGS. 24A and 24B illustrate reference frame configurations when a weighted prediction is applied. In FIGS. 24A and 24B, t represents the time of the encoding target frame and reference frame positions t-1, t-2 indicates that the reference frame thereof is positioned one frame and two frames past with respect to the encoding target frame respectively. In this example, the number of reference frames is four and the reference frame number is allocated to each reference frame.

In FIG. 24A, reference frames whose reference frame numbers are 0 and 1 are both reference frames in the position t-1, but are different in on/off of the weighted prediction. In this case, reference frames whose reference frame numbers are 0 and 1 are not handled as the same reference frame. That is, reference frames whose reference frame numbers are 0 and 1 and are different in on/off of the weighted prediction are regarded as different reference frames even if the reference frames are located in the same position. Therefore, when the condition (A) is included in the first condition and two kinds of motion information acquired from an encoded region each refer to reference frames corresponding to the reference frame numbers are 0 and 1, the predicted motion information setting module 1002 determines that the first condition is not satisfied because both kinds of motion information refer to the reference frames in the position t-1, but are different in on/off of the weighted prediction.

FIG. 24B illustrates a reference frame configuration when weighted prediction parameters are different. The weighted prediction parameters include a weight a and an offset b used for weighted prediction and are retained for each of luminance and color difference signals. In FIG. 24B, a weight a0 and an offset b0 of a luminance signal are retained for the reference frame whose reference frame number is 0 and a weight a1 and an offset b1 of a luminance signal are retained for the reference frame whose reference frame number is 1. In this case, reference frames whose reference frame numbers are 0, 1, and 2 are not handled as the same reference frame.

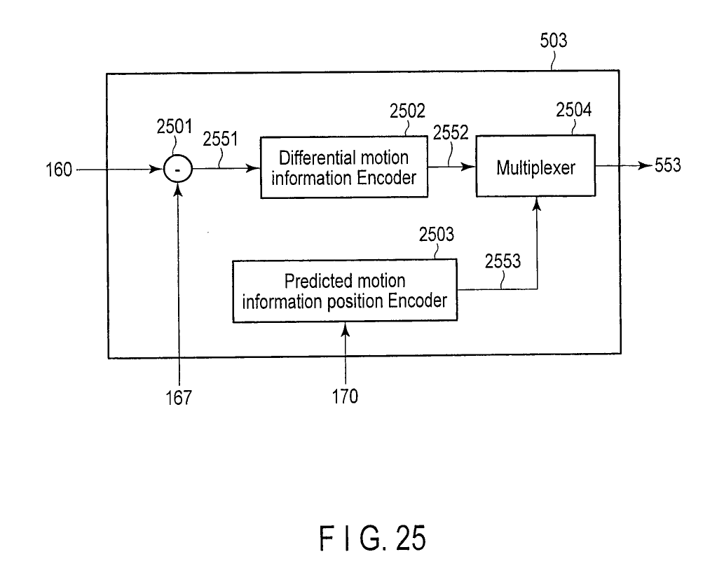

Next, the motion information encoder 503 will be described by referring to FIG. 25.

FIG. 25 illustrates the motion information encoder 503 in more detail. The motion information encoder 503 includes, as illustrated in FIG. 25, a subtractor 2501, a differential motion information encoder 2502, a predicted motion information position encoder 2503, and a multiplexer 2504.

The subtractor 2501 generates differential motion information 2551 by subtracting the predicted motion information 167 from the motion information 160. The differential motion information encoder 2502 generates encoded data 2552 by encoding the differential motion information 2551. In skip mode and merge mode, encoding of the differential motion information 2551 by the differential motion information encoder 2502 is not needed.

The predicted motion information position encoder 2503 encodes predicted motion information position information (the index Mpvidx illustrated in FIGS. 13A, 13B, and 13C) indicating which of predicted motion information candidates 1051-1 to 1051-Y is selected to generate encoded data 2553. The predicted motion information position information is contained in the encoding control information 170 from the encoding controller 120. The predicted motion information position information is encoded (equal-length encoded or variable-length encoded) by using a code table generated by the predicted motion information acquiring module 110 from the total number of the corrected predicted motion information candidates 1052. The predicted motion information position information may be variable-length encoded by using the correlation with adjacent blocks. Further, if a plurality of the corrected predicted motion information candidates 1052 include overlapping information, a code table may be created from the total number of the corrected predicted motion information candidates 1052 from which the overlapping predicted motion information candidates 1051 are deleted to encode the predicted motion information position information according to the code table. If the total number of corrected predicted motion information candidates is 1, the corrected predicted motion information candidate is decided as the predicted motion information 167 and the motion information candidate 160A and thus, there is no need to encode the predicted motion information position information.

The multiplexer 2504 multiplexes the encoded data 2552, 2553 to generate the encoded data 553.

In each of the skip mode, merge mode, and inter mode, the method of deriving the corrected predicted motion information candidates 1052 does not need to be the same and the derivation method of the corrected predicted motion information candidates 1052 may be set independently for each mode. In the present embodiment, the method of deriving the corrected predicted motion information candidates 1052 is the same in skip mode and merge mode and the method of deriving the corrected predicted motion information candidates 1052 in inter mode is different.

Next, the syntax used by the moving image encoding apparatus 100 in FIG. 1 will be described.

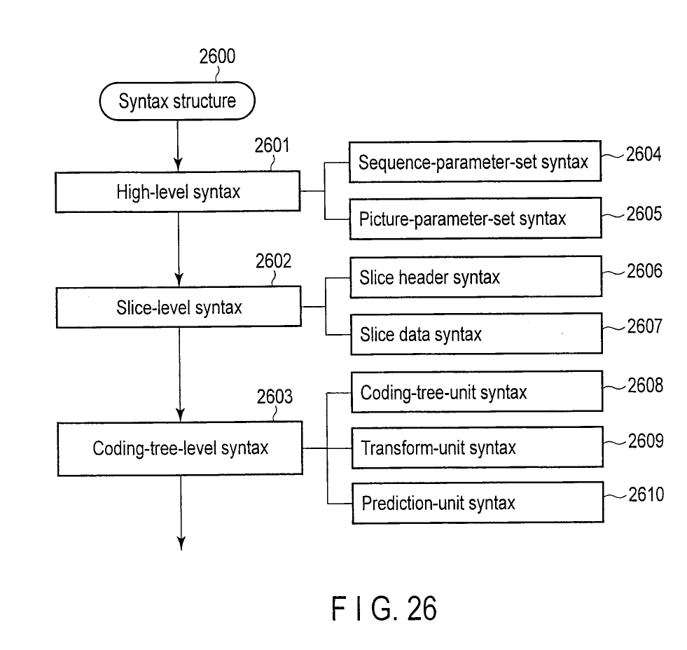

The syntax shows a structure of encoded data (for example, the encoded data 163 in FIG. 1) when the moving image encoding apparatus encodes moving image data. When the encoded data is decoded, the image decoding apparatus refers to the same syntax structure to perform a syntax interpretation. A syntax 2600 used by the moving image encoding apparatus 100 in FIG. 1 is illustrated in FIG. 26.

The syntax 2600 includes three parts, namely, a high-level syntax 2601, a slice-level syntax 2602, and a coding-tree-level syntax 2603. The high-level syntax 2601 includes syntax information on a layer higher than a slice. The slice means a rectangular region or a continuous region included in the frame or field. The slice-level syntax 2602 includes information necessary to decode each slice. The coding-tree-level syntax 2603 includes information necessary to decode each coding tree unit (that is, each coding tree unit). Each of these parts includes more detailed syntax.

The high-level syntax 2601 includes sequence-level and picture-level syntax such as a sequence-parameter-set syntax 2604 and a picture-parameter-set syntax 2605. The slice-level syntax 2602 includes a slice header syntax 2606 and a slice data syntax 2607. The coding-tree-level syntax 2603 includes a coding-tree-unit syntax 2608, a transform-unit syntax 2609, and a prediction-unit syntax 2610.

The coding-tree-unit syntax 2608 can have a quadtree structure. More specifically, the coding-tree-unit syntax 2608 can further be invoked recursively as a syntax element of the coding-tree-unit syntax 2608. That is, one coding tree unit can be segmented by the quadtree. The coding-tree-unit syntax 2608 includes the transform-unit syntax 2609 and the prediction-unit syntax 2610. The transform-unit syntax 2609 and the prediction-unit syntax 2610 are invoked in each of the coding-tree-unit syntaxes 2608 at an end of the quadtree. Information about a prediction is described in the prediction-unit syntax 2610 and information about an inverse orthogonal transform and quantization is described in the transform-unit syntax 2609.

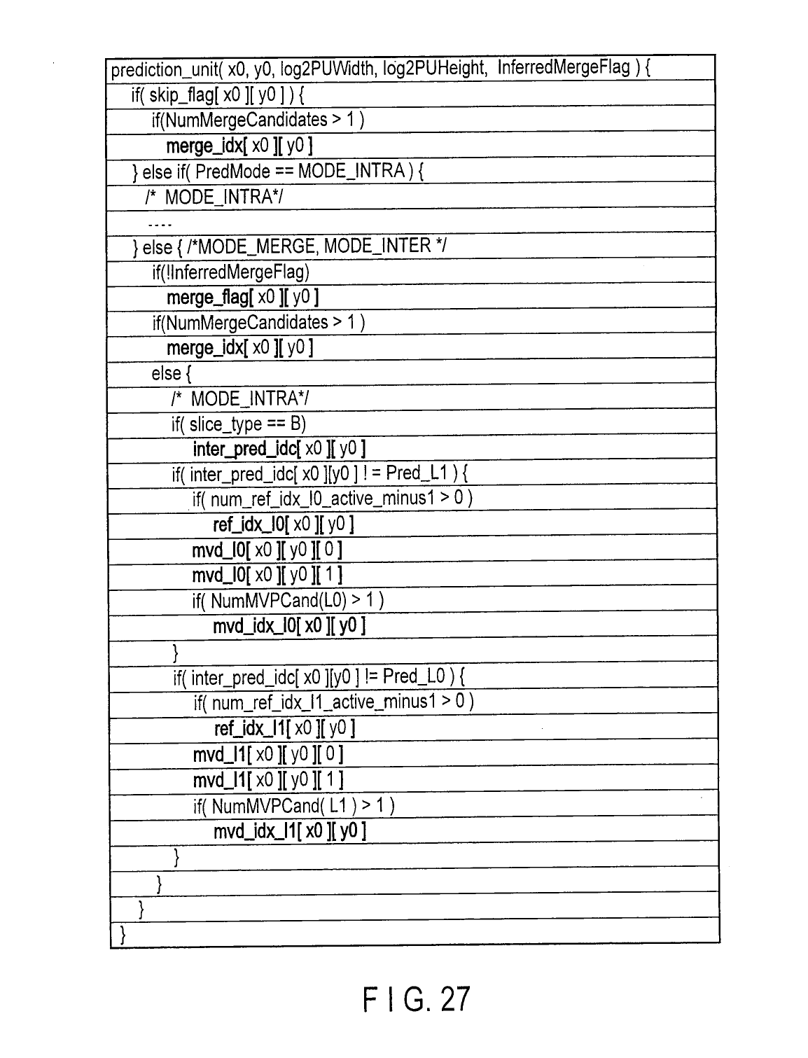

FIG. 27 illustrates an example of the prediction unit syntax. skip_flag illustrated in FIG. 27 is a flag indicating whether the prediction mode of the coding tree unit to which the prediction unit syntax belongs is the skip mode. If the prediction mode is the skip mode, skip_flag is set to 1. skip_flag being equal to 1 means that syntaxes (the coding-tree-unit syntax, the prediction-unit syntax, and the transform-unit syntax) other than predicted motion information position information 2554 are not encoded. NumMergeCandidates indicates, for example, the number of the corrected predicted motion information candidates 1052 generated by using the list in FIG. 13A. When the corrected predicted motion information candidates 1052 exist (NumMergeCandidates >1), merge_idx as the predicted motion information position information 2554 indicating which block of the corrected predicted motion information candidates 1052 to merge with is encoded. When merge_idx is not encoded, the value thereof is set to 0.

skip_flag being equal to 0 indicates that the prediction mode of the coding tree unit to which the prediction-unit syntax belongs is not the skip mode. NumMergeCandidates indicates, for example, the number of the corrected predicted motion information candidates 1052 generated by using the list in FIG. 13A. First, if InferredMergeFlag indicating whether to encode merge_flag described later is FALSE, merge_flag as a flag indicating whether the prediction mode of the prediction unit is the merge mode is encoded. merge_flag being equal to 1 indicates that the prediction mode of the prediction unit is the merge mode. merge_flag being equal to 0 indicates that the inter mode is applied to the prediction unit. When merge_flag is not encoded, the value of merge_flag is set to 1.

When merge_flag is 1 and the number of the corrected predicted motion information candidates 1052 is 2 or more (NumMergeCandidates >1), merge_idx as the predicted motion information position information 2554 indicating which block of the corrected predicted motion information candidates 1052 to merge with is encoded.

When merge_flag is 1, there is no need to encode the prediction-unit syntax other than merge_flag and merge_idx.

merge_flag being equal to 0 indicates that the prediction mode of the prediction unit is the inter mode. In inter mode, mvd_lX (X=0 or 1) indicating differential motion vector information contained in the differential motion information 2551 and the reference frame number ref_idx_lX are encoded. Further, if the prediction unit is a pixel block in a B slice, inter_pred_idc indicating whether the unidirectional prediction (the list 0 or the list 1) or the bidirectional prediction is applied to the prediction unit is encoded. In addition, NumMVPCand(L0) and NumMVPCand(L1) are acquired. NumMVPCand(L0) and NumMVPCand(L1) show the numbers of the corrected predicted motion information candidates 1052 in the list 0 prediction and the list 1 prediction respectively. When the corrected predicted motion information candidates 1052 exist (NumMVPCand(LX)>0, X=0 or 1), mvp_idx_lX indicating the predicted motion information position information 2554 is encoded.

The foregoing is the syntax configuration according to the present embodiment.

As described above, a moving image encoding apparatus according to the present embodiment sets motion information of the encoding target prediction unit by using motion information of encoded pixel blocks to perform an inter prediction and if the block referred to by motion information in the list 0 prediction and the block referred to by motion information in the list 1 prediction are the same, the prediction direction is set to the unidirectional prediction. Therefore, motion compensation processing and averaging processing in an inter prediction can be reduced. As a result, the amount of processing in an inter prediction can be reduced, leading to the improvement of encoding efficiency.

### Second Embodiment

In the second embodiment, a moving image decoding apparatus corresponding to the moving image encoding apparatus 100 in the first embodiment will be described. A moving image decoding apparatus according to the present embodiment decodes, for example, encoded data generated by the moving image encoding apparatus 100 in the first embodiment.

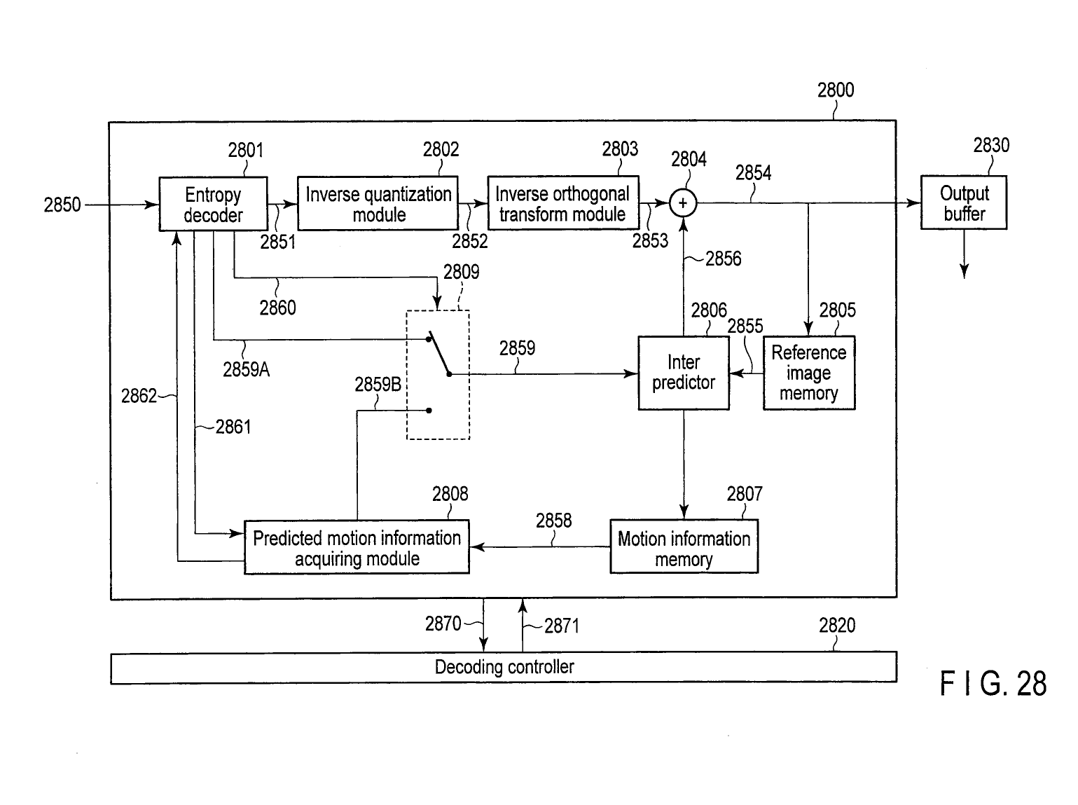

FIG. 28 schematically illustrates a moving image decoding apparatus 2800 according to the second embodiment. In the moving image decoding apparatus 2800, encoded data 2850 is input, for example, from the moving image encoding apparatus 100 in FIG. 1 or the like through a storage system or a transmission system. The moving image decoding apparatus 2800 decodes the received encoded data 2850 to generate a decoded image signal 2854. The generated decoded image signal 2854 is temporarily stored in an output buffer 2830 before being sent out as an output image. More specifically, the moving image decoding apparatus 2800 includes, as illustrated in FIG. 28, an entropy decoder 2801, an inverse quantization module 2802, an inverse orthogonal transform module 2803, an adder 2804, a reference image memory 2805, an inter-predictor 2806, a reference motion information memory 2807, a predicted motion information acquiring module 2808, a motion information selection switch 2809, and a decoding controller 2820. Further, the moving image decoding apparatus 2800 may further include an intra prediction unit (not illustrated).

The moving image decoding apparatus 2800 in FIG. 28 can be realized by hardware such as an LSI (Large-Scale Integration circuit) chip, DSP (Digital Signal Processor), and FPGA (Field Programmable Gate Array). The moving image decoding apparatus 2800 can also be realized by causing a computer to execute an image decoding program.

The entropy decoder 2801 performs decoding based on syntax to decode the encoded data 2850. The entropy decoder 2801 successively entropy-decodes a code sequence of each syntax to reproduce encoding parameters about the decoding target block such as motion information 2859A, prediction information 2860, and a quantized transform coefficient 2851. The encoding parameters are parameters needed for decoding such as prediction information, information about a transform coefficient, and information about quantization.

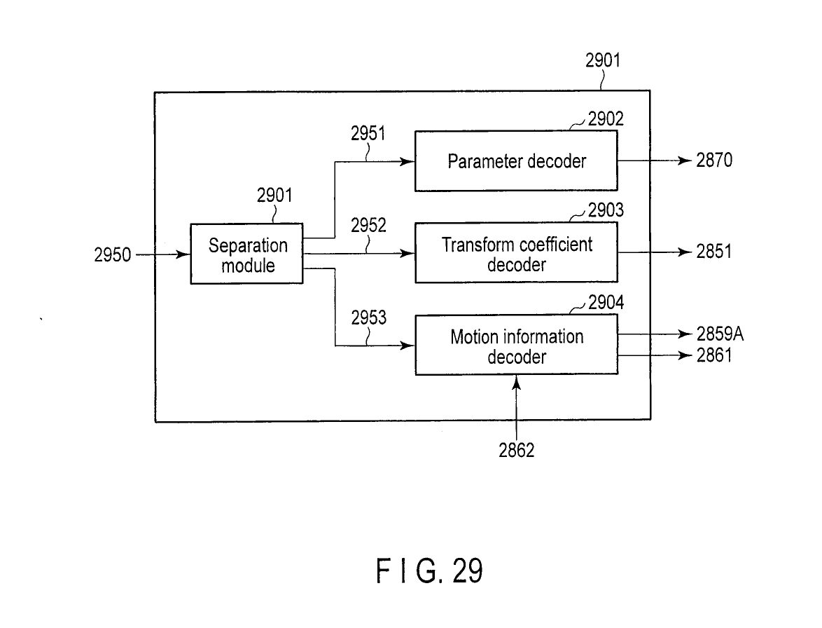

More specifically, the entropy decoder 2801 includes, as illustrated in FIG. 29, a separation module 2901, a parameter decoder 2902, a transform coefficient decoder 2903, and a motion information decoder 2904. The separation module 2901 separates the encoded data 2850 into encoded data 2951 on parameters, encoded data 2952 on transform coefficients, and encoded data 2953 on motion information. The separation module 2901 outputs the encoded data 2951 on parameters to the parameter decoder 2902, the encoded data 2952 on transform coefficients to the transform coefficient decoder 2903, and the encoded data 2953 on motion information to the motion information decoder 2904.

The parameter decoder 2902 decodes the encoded data 2951 on parameters to obtain encoding parameters 2870 of the prediction information 2860 and the like. The parameter decoder 2902 outputs the encoding parameters 2870 to the decoding controller 2820. The prediction information 2860 is used to switch which of the inter prediction and the intra prediction to apply to the decoding target prediction unit and also to switch which motion information candidates 2859A output from the motion information decoder 2904 and motion information candidates 2859B output from the predicted motion information acquiring module 2808 to use by the motion information selection switch 2809.

The transform coefficient decoder 2903 decodes the encoded data 2952 to obtain the quantized transform coefficient 2851. The transform coefficient decoder 2903 outputs the quantized transform coefficient 2851 to the inverse quantization module 2802.

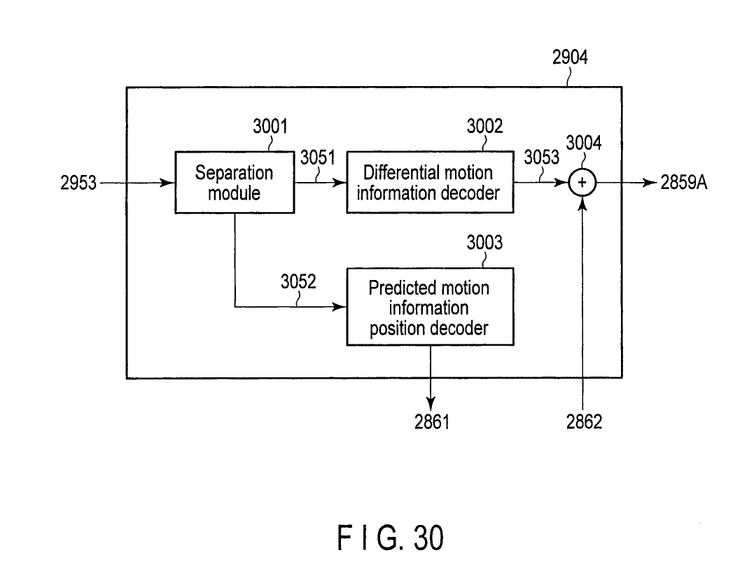

The motion information decoder 2904 decodes the encoded data 2953 from the separation module 2901 to generate predicted motion information position information 2861 and the motion information 2859A. More specifically, the motion information decoder 2904 includes, as illustrated in FIG. 30, a separation module 3001, a differential motion information decoder 3002, a predicted motion information position decoder 3003, and an adder 3004.

In the motion information decoder 2904, the encoded data 2953 on motion information is input into the separation module 3001. The separation module 3001 separates the encoded data 2953 into encoded data 3051 on differential motion information and encoded data 3052 on predicted motion information positions.

The differential motion information decoder 3002 decodes the encoded data 3051 on differential motion information to obtain differential motion information 3053. In skip mode and merge mode, decoding of the differential motion information 3053 by the differential motion information decoder 3002 is not needed.

The adder 3004 adds the differential motion information 3053 to predicted motion information 2862 from the predicted motion information acquiring module 2808 to generate motion information 2859A. The motion information 2859A is sent out to the motion information selection switch 2809.

The predicted motion information position decoder 3003 decodes the encoded data 3052 on predicted motion information positions to obtain the predicted motion information position information 2861. The predicted motion information position information 2861 is sent out to the predicted motion information acquiring module 2808.

The predicted motion information position information 2861 is decoded (equal-length decoded or variable-length decoded) by using a code table generated based on the total number of the corrected predicted motion information candidates 1052. The predicted motion information position information 2861 may be variable-length decoded by using the correlation with adjacent blocks. Further, if a plurality of the corrected predicted motion information candidates 1052 overlaps, the predicted motion information position information 2861 may be decoded according to a code table generated based on the total number of the corrected predicted motion information candidates 1052 from which the overlapping predicted motion information candidates are deleted. If the total number of the corrected predicted motion information candidates 1052 is 1, the corrected predicted motion information candidate 1052 is decided as the predicted motion information candidate 2859B and thus, there is no need to decode the predicted motion information position information 2861.

The inverse quantization module 2802 illustrated in FIG. 28 inversely quantizes the quantized transform coefficient 2851 from the entropy decoder 2801 to obtain a restored transform coefficient 2852. More specifically, the inverse quantization module 2802 performs inverse quantization processing according to quantization information obtained by the entropy decoder 2801. The inverse quantization module 2802 outputs the restored transform coefficient 2852 to the inverse orthogonal transform module 2803.

The inverse orthogonal transform module 2803 performs an inverse orthogonal transform corresponding to an orthogonal transform on the encoding side on the restored transform coefficient 2852 from the inverse quantization module 2802 to obtain a restored prediction error signal 2853. If, for example, the orthogonal transform by the orthogonal transform module 102 in FIG. 1 is DCT, the inverse orthogonal transform module 2803 performs IDCT. The inverse orthogonal transform module 2803 outputs the restored prediction error signal 2853 to the adder 2804.

The adder 2804 adds the restored prediction error signal 2853 and a corresponding predicted image signal 2856 to generate the decoded image signal 2854. The decoded image signal 2854 is temporarily stored in the output buffer 2830 as an output image signal after filtering processing being performed thereon. The decoded image signal 2854 stored in the output buffer 2830 is output in an appropriate output timing managed by the decoding controller 2820. For the filtering of the decoded image signal 2854, for example, a deblocking filter or a Wiener filter is used.

Further, the decoded image signal 2854 after the filtering processing is stored also in the reference image memory 2805 as a reference image signal 2855. The reference image signal 2855 stored in the reference image memory 2805 is referred to by the inter-predictor 2806 in frame units or field units when necessary.

The inter-predictor 2806 performs an inter prediction using the reference image signal 2855 stored in the reference image memory 2805. More specifically, the inter-predictor 2806 receives motion information 2859 including an amount of shifts (motion vector) between the prediction target block and the reference image signal 2855 from the motion information selection switch 2809 and generates an inter predicted image by performing interpolation processing (motion compensation) based on the motion vector. The generation of an inter predicted image is the same as in the first embodiment and thus, a detailed description thereof is omitted.

The motion information memory 2807 temporarily stores the motion information 2859 used for inter prediction by the inter-predictor 2806 as reference motion information 2858. The motion information memory 2807 has the same function as that of the motion information memory 109 shown in the first embodiment and thus, a duplicate description is omitted when appropriate. The reference motion information 2858 is stored in frame (or slice) units. More specifically, the motion information memory 2807 includes a spatial direction reference motion information memory that stores the motion information 2859 of the decoding target frame as the reference motion information 2858 and a temporal direction reference motion information memory that stores the motion information 2859 of decoded frames as the reference motion information 2858. As many temporal direction reference motion information memories as reference frames used for predicting the decoding target frame can be provided.

The reference motion information 2858 is stored in the spatial direction reference motion information memory and the temporal direction reference motion information memory in predetermined region units (for example, the 4×4 pixel block unit). The reference motion information 2858 further contains information indicating which of the inter prediction and the intra prediction is applied to the region thereof.

The predicted motion information acquiring module 2808 refers to the reference motion information 2858 stored in the motion information memory 2807 to generate the motion information candidates 2859B used for the decoding target prediction unit and the predicted motion information 2862 used for differential decoding of motion information by the entropy decoder 2801.

The decoding controller 2820 controls each unit of the moving image decoding apparatus 2800 in FIG. 28. More specifically, the decoding controller 2820 exercises various kinds of control for decoding processing by receiving information including the encoding parameters 2870 from the entropy decoder 2801 from the moving image decoding apparatus 2800 and providing decoding control information 2871 to the moving image decoding apparatus 2800.

The moving image decoding apparatus 2800 according to the present embodiment uses, like the encoding processing described by referring to FIG. 9, a plurality of different prediction modes of decoding processing. The skip mode is a mode in which only the syntax of the predicted motion information position information 2861 is decoded and other syntaxes are not decoded. The merge mode is a mode in which the syntax of the predicted motion information position information 2861 and information about transform coefficients are decoded and other syntaxes are not decoded. The inter mode is a mode in which the syntax of the predicted motion information position information 2861, differential motion information, and information about transform coefficients are decoded. These modes are switched by prediction information controlled by the decoding controller 2820.

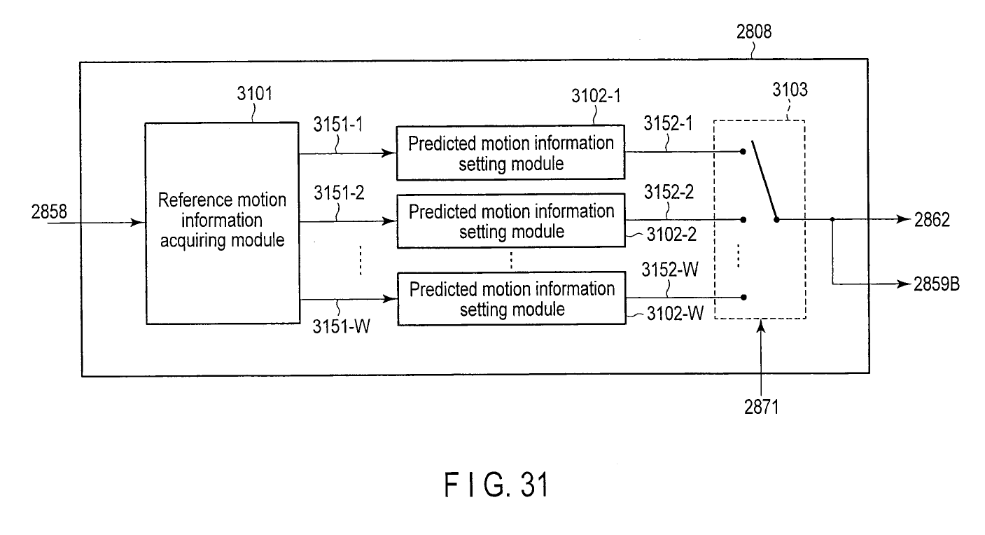

FIG. 31 illustrates the predicted motion information acquiring module 2808 in more detail. The predicted motion information acquiring module 2808 has the same configuration as that of the predicted motion information acquiring module 110 of a moving image encoding apparatus as illustrated in FIG. 10 and thus, a detailed description of the predicted motion information acquiring module 2808 is omitted.

The predicted motion information acquiring module 2808 illustrated in FIG. 31 includes a reference motion information acquiring module 3101, motion information setting modules 3102-1 to 3102-W, and a predicted motion information selection switch 3103. W represents the number of predicted motion information candidates generated by the reference motion information acquiring module 3101.

The reference motion information acquiring module 3101 acquires the reference motion information 2858 from the motion information memory 2807. The reference motion information acquiring module 3101 uses the acquired reference motion information 2858 to generate one or more predicted motion information candidates 3151-1, 3151-2, . . . , 3151-W. The predicted motion information candidates are also called predicted motion vector candidates.

The predicted motion information setting modules 3102-1 to 3102-W receive the predicted motion information candidates 3151-1 to 3151-W from the reference motion information acquiring module 3101 and generate corrected predicted motion information candidates 3152-1 to 3152-W respectively by setting the prediction method (the unidirectional prediction or the bidirectional prediction) applied to the decoding target prediction unit and the reference frame number and scaling motion vector information.

The predicted motion information selection switch 3103 selects one candidate from one or more corrected predicted motion information candidates 3152-1 to 3152-W according to an instruction contained in the decoding control information 2871 from the decoding controller 2820. Then, the predicted motion information selection switch 3103 outputs the selected candidate to the motion information selection switch 2809 as the motion information candidate 2859B and also outputs the predicted motion information 2862 used for differential decoding of motion information by the entropy decoder 2801. Typically, the motion information candidate 2859B and the predicted motion information 2862 contain the same motion information, but may contain mutually different motion information according to an instruction of the decoding controller 2820. Instead of the decoding controller 2820, the predicted motion information selection switch 3103 may output the predicted motion information position information. The decoding controller 2820 decides which of the corrected predicted motion information candidates 3152-1 to 3152-W to select by using an evaluation function like, for example, Formula (1) or Formula (2).

When the motion information candidate 2859B is selected by the motion information selection switch 2809 as the motion information 2859 and stored in the motion information memory 2807, the list 0 predicted motion information candidate retained by the motion information candidate 2859B may be copied to the list 1 predicted motion information candidate. In this case, the reference motion information 2858 containing list 0 predicted motion information and list 1 predicted motion information, which is the same information as the list 0 predicted motion information, is used by the predicted motion information acquiring module 2808 as the reference motion information 2858 of an adjacent prediction unit when the subsequent prediction unit is decoded.

When the predicted motion information setting modules 3102-1 to 3102-W, the predicted motion information candidates 3151-1 to 3151-W, and the corrected predicted motion information candidates 3152-1 to 3152-W are each described without particularly distinguishing from one another, the number (“-1” to “W”) at the end of the reference numeral is omitted to simply refer to the predicted motion information setting module 3102, the predicted motion information candidates 3151, and the corrected predicted motion information candidates 3152.

The predicted motion information setting module 3102 generates at least the one predicted motion information candidate 3151 by, for example, a method similar to that of the reference motion information acquiring module 1001 of the moving image encoding apparatus 100 illustrated in FIG. 10. The method of generating the predicted motion information candidate 3151 is the same as that described for the moving image encoding apparatus by referring to

FIGS. 11A to 17F and thus, a detailed description thereof is omitted.

As an example, the method of generating the predicted motion information candidate 3151 by the reference motion information acquiring module 3101 according to the list in FIG. 13A will briefly be described. According to the list in FIG. 13A, the two predicted motion information candidates 3151-1, 3151-2 are generated by referring to prediction units spatially adjacent to the decoding target prediction unit and the one predicted motion information candidate 3151-3 is generated by referring to prediction units temporally adjacent to the decoding target prediction unit.

For example, as illustrated in FIG. 11A, adjacent prediction units to which an inter prediction is applied are selected from the adjacent prediction units A_{X} (X=0, 1, . . . , nA-1) and the position of the adjacent prediction unit having the smallest value of X among the selected adjacent prediction units is decided as the block position A. The predicted motion vector candidate 3151-1 whose index Mvpidx is 0 is generated from reference motion information of an adjacent prediction unit of the block position A positioned in the spatial direction.

Also, for example, as illustrated in FIG. 11A, adjacent prediction units to which an inter prediction is applied are selected from the adjacent prediction units B_{Y}(Y=0, 1, . . . , nB−1) and the position of the adjacent prediction unit having the smallest value of Y among the selected adjacent prediction units is decided as the block position B. The predicted motion vector candidate 3151-2 whose block position index Mvpidx is 1 is generated from reference motion information of an adjacent prediction unit of the block position B positioned in the spatial direction.

Further, the predicted motion vector candidate 3151-3 whose block position index Mvpidx is 2 is generated from reference motion information of an adjacent prediction unit of the position Col in the reference frame.

In this manner, the reference motion information acquiring module (also called a predicted motion information candidate generator) 3101 generates one or more predicted motion information candidates 3151-1 to 3151-W by referring to the motion information memory 2807. Adjacent prediction units referred to for the generation of the predicted motion information candidates 3151, that is, adjacent prediction units from which predicted motion information candidates are acquired or output are called reference motion blocks. When a unidirectional prediction is applied to the reference motion block, the predicted motion information candidates 3151 contain one of list 0 predicted motion information candidates used for a list 0 prediction and list 1 predicted motion information candidates used for a list 1 prediction. When a bidirectional prediction is applied to the reference motion block, the predicted motion information candidates 3151 contain both of list 0 predicted motion information candidates and list 1 predicted motion information candidates.

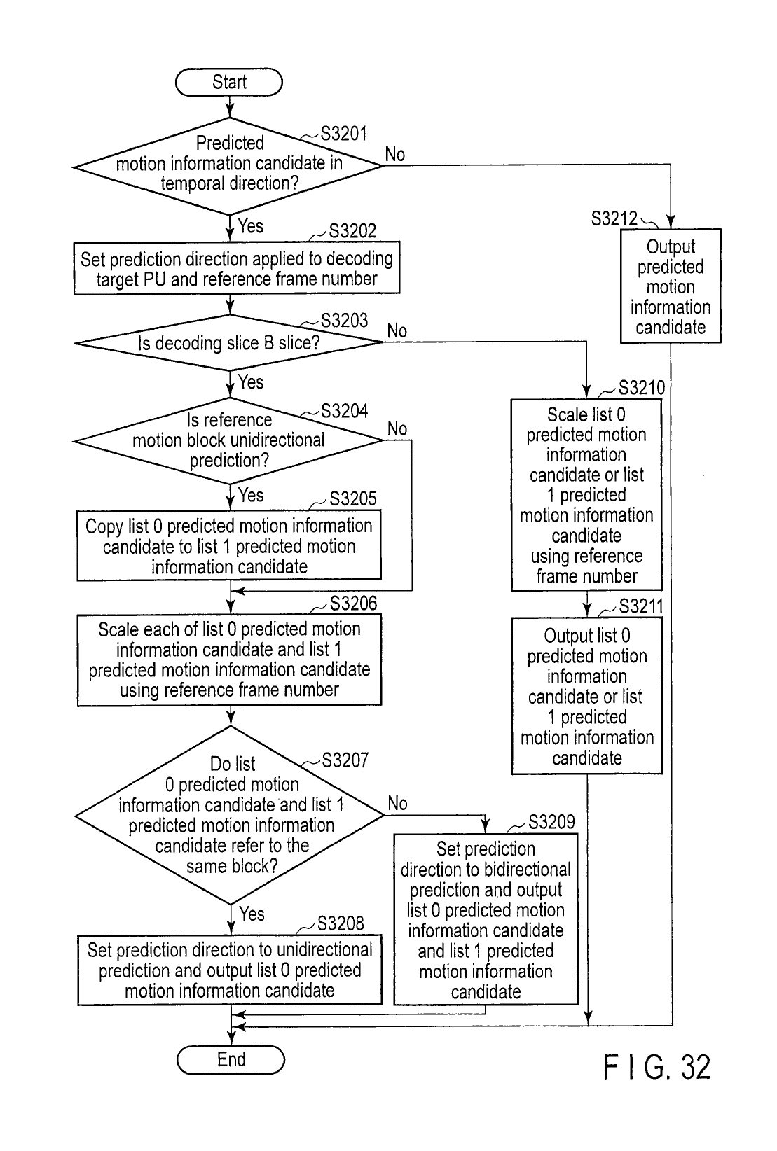

FIG. 32 illustrates an example of processing of the predicted motion information setting module 3102. The predicted motion information setting module 3102 illustrated in FIG. 32 has the same function as that of the predicted motion information setting module 1002 of the moving image encoding apparatus 100 illustrated in FIG. 10. The processing procedure in FIG. 32 can be understood by replacing “encoding” in the description of the processing procedure in FIG. 18 by “decoding” and thus, a detailed description thereof is omitted when appropriate.

As illustrated in FIG. 32, the predicted motion information setting module 3102 first determines whether the predicted motion information candidate 3151 has been output from a reference motion block in the spatial direction or a reference motion block in the temporal direction (step S3201). If the predicted motion information candidate 3151 has been output from a reference motion block in the spatial direction (the determination in step S3101 is NO), the predicted motion information setting module 3102 outputs the predicted motion information candidate 3151 as the corrected predicted motion information candidate 3152 (step S3212).

If the predicted motion information candidate 3151 has been output from a reference motion block in the temporal direction (the determination in step S3202 is YES), the predicted motion information setting module 3102 sets the prediction direction to be applied to the decoding target prediction unit and the reference frame number (step S3202). More specifically, if the decoding target prediction unit is a pixel block in a P slice to which only the unidirectional prediction is applied, the prediction direction is set to the unidirectional prediction. Further, if the decoding target prediction unit is a pixel block in a B slice to which the unidirectional prediction and the bidirectional prediction can be applied, the prediction direction is set to the bidirectional prediction. The reference frame number is set by referring to decoded prediction units positioned in the spatial direction. For example, the reference frame number is decided by a majority vote using the reference frame number of the prediction unit in a predetermined position adjacent to the decoding target prediction unit.

Next, the predicted motion information setting module 3102 determines whether the slice (also called a decoding slice) to which the decoding target prediction unit belongs is a B slice (step S3203). If the decoding slice is a P slice (the determination in step S3203 is NO), the predicted motion information candidates 3151 contain one of the list 0 predicted motion information candidates and the list 1 predicted motion information candidates. In this case, the predicted motion information setting module 3102 scales a motion vector contained in the list 0 predicted motion information candidate or the list 1 predicted motion information candidate using the reference frame number set in step S3202 (step S3210). Further, the predicted motion information setting module 3102 outputs the list 0 predicted motion information candidate or the list 1 predicted motion information candidate containing the scaled motion vector as the corrected predicted motion information candidate 3152 (step S3211).

If the decoding slice is a B slice (the determination in step S3203 is YES), the predicted motion information setting module 3102 determines whether the unidirectional prediction is applied to the reference motion block (step S3204). If the unidirectional prediction is applied to the reference motion block (the determination in step S3204 is YES), the list 1 predicted motion information candidate does not exist in the predicted motion information candidates 3151 and thus, the predicted motion information setting module 3102 copies the list 0 predicted motion information candidate to the list 1 predicted motion information candidate (step S3205). If the bidirectional prediction is applied to the reference motion block (the determination in step S3204 is NO), the processing proceeds to step S3206 by skipping step S3205.

Next, the predicted motion information setting module 3102 scales a motion vector of the list 0 predicted motion information candidate and a motion vector of the list 1 predicted motion information candidate using the reference frame number set in step S3202 (step S3206). Next, the predicted motion information setting module 3102 determines whether the block referred to by the list 0 predicted motion information candidate and the block referred to by the list 1 predicted motion information candidate are the same (step S3207).

If the block referred to by the list 0 predicted motion information candidates and the block referred to by the list 1 predicted motion information candidates are the same (the determination in step S3207 is YES), a predicted value (predicted image) generated by the bidirectional prediction is equivalent to a predicted value (predicted image) generated by the unidirectional prediction. Thus, the predicted motion information setting module 3102 changes the prediction direction from the bidirectional prediction to the unidirectional prediction and outputs the corrected predicted motion information candidate 3152 containing the list 0 predicted motion information candidate (step S3208). Thus, if the block referred to by the list 0 predicted motion information candidates and the block referred to by the list 1 predicted motion information candidates are the same, motion compensation processing and averaging processing in an inter prediction can be reduced by changing the prediction direction from the bidirectional prediction to the unidirectional prediction.

If the block referred to by the list 0 predicted motion information candidate and the block referred to by the list 1 predicted motion information candidate are not the same (the determination in step S3207 is NO), the predicted motion information setting module 3102 sets the prediction direction to the bidirectional prediction and outputs the corrected predicted motion information candidates 3152 containing the list 0 predicted motion information candidate and the list 1 predicted motion information candidate (step S3209).

According to the present embodiment, as described above, motion information of the decoding target prediction unit is set by using motion information of decoded pixel blocks to perform an inter prediction and if the block referred to by motion information in the list 0 prediction and the block referred to by motion information in the list 1 prediction are the same, the prediction direction is set to the unidirectional prediction. Therefore, motion compensation processing and averaging processing in an inter prediction can be reduced. As a result, the amount of processing in an inter prediction can be reduced.

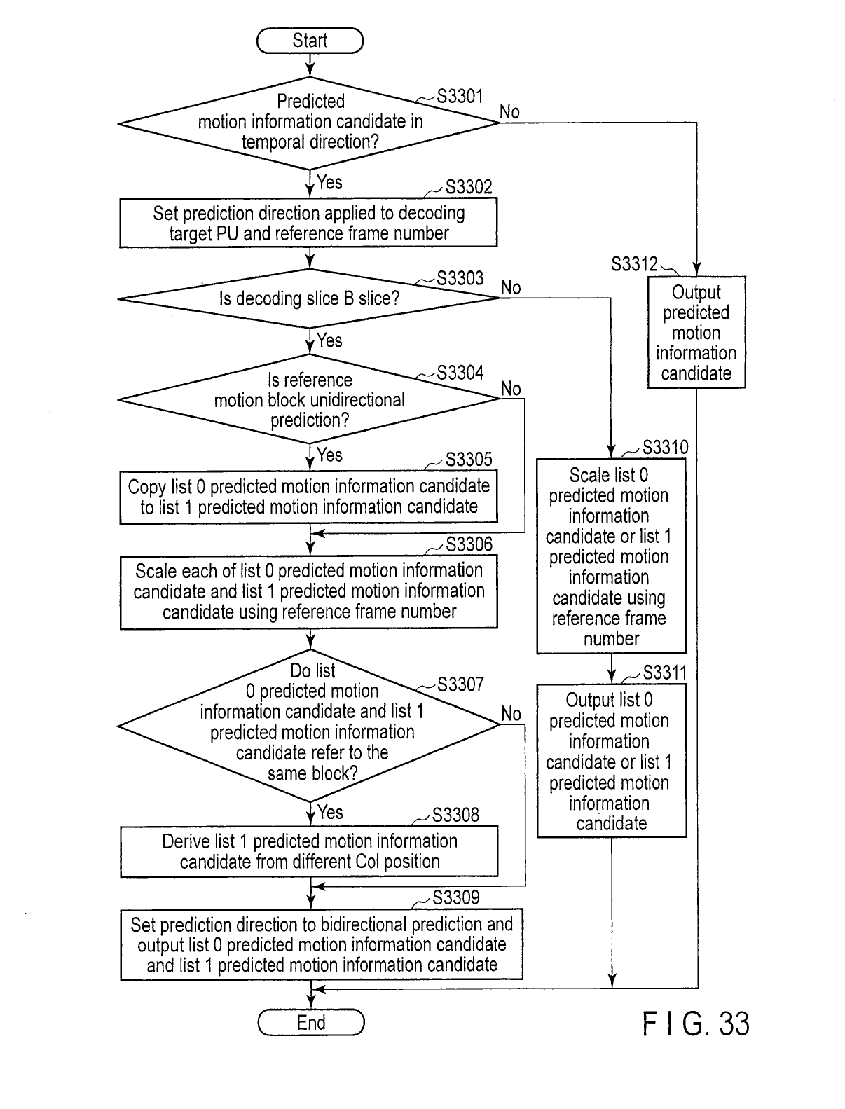

Next, another embodiment of processing of the predicted motion information setting module 3102 will be described by using the flow chart in FIG. 33. The processing procedure in FIG. 33 can be understood by replacing “encoding” in the description of the processing procedure in FIG. 20 by “decoding” and thus, a detailed description thereof is omitted when appropriate. Steps S3301 to S3306, S3310 to S3312 in FIG. 33 are the same as steps S3201 to S3206, S3210 to S3212 in FIG. 32 and thus, the description thereof is omitted.

In step S3307, the predicted motion information setting module 3102 determines whether the block referred to by the list 0 predicted motion information candidate and the block referred to by the list 1 predicted motion information candidate, which are generated in steps S3301 to S3306, are the same. If the block referred to by the list 0 predicted motion information candidate and the block referred to by the list 1 predicted motion information candidate are the same (the determination in step S3307 is YES), a predicted value (predicted image) generated by the bidirectional prediction is equivalent to a predicted value (predicted image) generated by the unidirectional prediction. Thus, the predicted motion information setting module 3102 derives the list 1 predicted motion information candidate again from a position spatially different from the reference motion information acquisition position from which the list 1 predicted motion information candidate has been derived (step S3308). Hereinafter, the reference motion information acquisition position used when the processing illustrated in FIG. 33 is started is called a first reference motion information acquisition position and the reference motion information acquisition position used to derive reference motion information again in step S3308 is called a second reference motion information acquisition position.

Typically, the first reference motion information acquisition position is set to, as indicated by a circle in FIG. 17A, a position circumscribing the lower right of the prediction unit in the position Col inside a reference frame and the second reference motion information acquisition position is set to, as indicated by a circle in FIG. 14A, a predetermined position inside the prediction unit in the position Col of the same reference frame. The first reference motion information acquisition position and the second reference motion information acquisition position may be positioned in reference frames that are mutually temporally different or set to spacio-temporally different positions.

According to this embodiment, as described above, motion information of the decoding target prediction unit is set by using motion information of decoded pixel blocks to perform an inter prediction and if the block referred to by motion information in the list 0 prediction and the block referred to by motion information in the list 1 prediction are the same, motion information in the list 1 prediction is acquired by a method different from an acquisition method of motion information in the list 0 prediction. Therefore, a bidirectional prediction whose prediction efficiency is higher than that of the unidirectional prediction can be realized. Two kinds of motion information suitable for bidirectional prediction can be acquired by setting the acquisition position of motion information in the list 1 prediction to a closer position in accordance with the conventional acquisition position, which leads to further improvement of prediction efficiency.

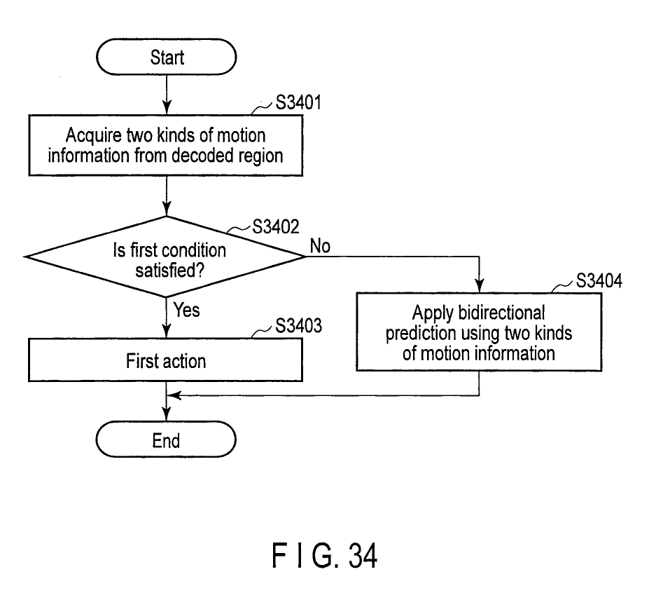

Next, still another embodiment of processing of the predicted motion information setting module 3102 will be described by using the flow chart in FIG. 34. The processing procedure in FIG. 34 can be understood by replacing “encoding” in the description of the processing procedure in FIG. 22 by “decoding”.

As illustrated in FIG. 34, the predicted motion information setting module 3102 acquires two kinds of motion information (the first predicted motion information and the second predicted motion information) from a decoded region (step S3401). For example, two kinds of motion information can be acquired from the aforementioned reference motion information acquisition positions. As a method of acquiring two kinds of motion information, motion information with high frequency may be used by calculating the frequency of motion information adapted to the decoding target prediction unit in advance or predetermined motion information may be used.

Next, the predicted motion information setting module 3102 determines whether the two kinds of motion information acquired in step S3401 satisfy a first condition (step S3402). The first condition includes at least one of conditions (A) to (F) shown below:

(A) Two kinds of motion information refer to the same reference frame;

(B) Two kinds of motion information refer to the same reference block;

(C) Reference frame numbers contained in two kinds of motion information are the same;

(D) Motion vectors contained in two kinds of motion information are the same;

(E) The absolute value of a difference between motion vectors contained in two kinds of motion information is equal to a predetermined threshold or less; and

(F) The numbers of reference frames and the configurations used for a list 0 prediction and a list 1 prediction are the same.

If, in step S3402, at least one of the conditions (A) to (F) is satisfied, two kinds of motion information are determined to satisfy the first condition. Alternatively, the first condition may always be determined to be satisfied. The same first condition as that set to the moving image encoding apparatus 100 described in the first embodiment is set to the moving image decoding apparatus 2800. Alternatively, the moving image decoding apparatus 2800 may receive information about the first condition from the moving image encoding apparatus 100 as additional information.

If the first condition is not satisfied (the determination in step S3402 is NO), a bidirectional prediction is applied to the decoding target prediction unit without changing two kinds of motion information (step S3404). If the first condition is satisfied (the determination in step S3402 is YES), the predicted motion information setting module 3102 performs a first action (step S3403). The first action includes one or more of actions (1) to (6) shown below:

(1) Set the prediction method to the unidirectional prediction and output one of two kinds of motion information as a list 0 predicted motion information candidate;

(2) Set the prediction method to the bidirectional prediction and acquire motion information from a block position spatially different from the acquisition position of motion information to output two kinds of motion information as a list 0 predicted motion information candidate and a list 1 predicted motion information candidate;

(3) Set the prediction method to the bidirectional prediction and acquire motion information from a block position temporally different from the acquisition position of motion information to output two kinds of motion information as a list 0 predicted motion information candidate and a list 1 predicted motion information candidate;

(4) Set the prediction method to the bidirectional prediction and change the reference frame number contained in motion information to output two kinds of motion information as a list 0 predicted motion information candidate and a list 1 predicted motion information candidate; and

(5) Set the prediction method to the bidirectional prediction and change a motion vector contained in motion information to output two kinds of motion information as a list 0 predicted motion information candidate and a list 1 predicted motion information candidate.

The actions (2) to (5) may be applied to only one of two kinds of motion information or both kinds of motion information. Typically, in the action (4), instead of the reference frame from which original motion information is acquired, the reference frame closest to the decoding target frame is applied. Typically, in the action (5), a motion vector obtained by shifting a motion vector by a fixed value is applied.

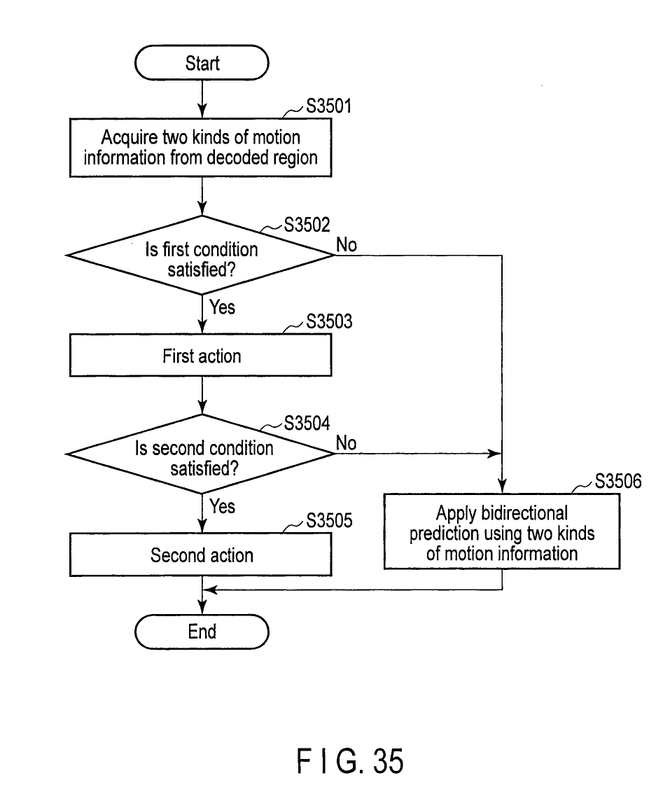

Next, still another embodiment of processing of the predicted motion information setting module 3102 will be described by using the flow chart in FIG. 35. Steps S3501 to S3503, S3506 in FIG. 35 are processing similar to steps S3401 to S3403, S3404 illustrated in FIG. 34 respectively and thus, the description of these steps is omitted. The processing procedure in FIG. 35 is different from that in FIG. 34 in that the determination of a second condition (step S3504) and a second action (step S3505) are added after the first action shown in step S3503. As an example, a case when the condition (B) is used as the first condition and the second condition and also the action (2) is used as the first action and the action (1) is used as the second action will be described.

In the action (2), motion information is acquired from a spatially different block position. Thus, if the motion information does not change spatially, the motion information is the same before and after the first action. If the motion information is the same before and after the first action as described above, the amount of processing of motion compensation is reduced by setting the prediction direction to the unidirectional prediction by applying the second action (step S3505). Therefore, the present embodiment can improve the prediction efficiency of the bidirectional prediction and also reduce the amount of processing of motion compensation when motion information does not change spatially.

In the present embodiment, the weighted prediction shown in H.264 may be applied. If, as illustrated FIG. 24A, reference frames whose reference frame numbers are 0 and 1 are both reference frames in the position t-1, but are different in on/off of the weighted prediction, reference frames whose reference frame numbers are 0 and 1 are not handled as the same reference frame. That is, reference frames whose reference frame numbers are 0 and 1 are different in on/off of the weighted prediction are regarded as different reference frames even if the reference frames are located in the same position.

Therefore, when the condition (A) is included in the first condition and two kinds of motion information acquired from a decoded region each refer to reference frames corresponding to the reference frame numbers are 0 and 1, the predicted motion information setting module 3102 determines that the first condition is not satisfied because both kinds of motion information refer to the reference frames in the position t-1, but are different in on/off of the weighted prediction.

When, as illustrated in FIG. 23B, a weight a0 and an offset b0 of a luminance signal are retained for the reference frame whose reference frame number is 0 and a weight a1 and an offset b1 of a luminance signal are retained for the reference frame whose reference frame number is 1, the reference frame numbers 0, 1, 2 are not handled as the same reference frame.

The moving image decoding apparatus 2800 in FIG. 28 can use the same syntax as that described by referring to FIG. 26 or a similar one and thus, a detailed description thereof is omitted.

As described above, a moving image decoding apparatus according to the present embodiment sets motion information of the decoding target prediction unit by using motion information of decoded pixel blocks to perform an inter prediction and if the block referred to by motion information in the list 0 prediction and the block referred to by motion information in the list 1 prediction are the same, the prediction direction is set to the unidirectional prediction. Motion compensation processing and averaging processing in an inter prediction can be reduced. As a result, the amount of processing in an inter prediction can be reduced, leading to the improvement of decoding efficiency.

Modifications of each embodiment will be described below.

In the first and second embodiments, examples in which each frame forming an input image signal is divided into rectangular blocks of a 16×16-pixel size or the like and, as shown in FIG. 2, encoding/decoding is sequentially performed from the upper-left block on the frame toward the lower-right block are described. However, the encoding order and the decoding order are not limited to those of such examples. For example, the encoding and the decoding may sequentially be performed from the lower-right block toward the upper-left block, or the encoding and the decoding may spirally be performed from the center of the frame toward the frame end. Further, the encoding and the decoding may sequentially be performed from the upper-right block toward the lower-left block, or the encoding and the decoding may spirally be performed from the frame end toward the center of the frame.

Also, the first and second embodiments have been described by illustrating the prediction target block sizes such as a 4×4-pixel block, an 8×8-pixel block, and a 16×16-pixel block, but the prediction target block may not have a uniform block shape. For example, the size of the prediction target block (prediction unit) may be a 16×8-pixel block, an 8×16-pixel block, an 8×4-pixel block, or a 4×8-pixel block. In addition, it is not necessary to unify all the block sizes in one coding tree unit and the different block sizes may be mixed. When the different block sizes are mixed in one coding tree unit, the code amount necessary to encode or decode division information also increases with an increasing division number. Therefore, the block size is desirably selected in consideration of a balance between the code amount of the division information and the quality of the locally-decoded image or the decoded image.

Further, in the first and second embodiments, for the sake of simplicity, the luminance signal and the color-difference signal are not distinguished from each other and a comprehensive description is provided about the color signal component. However, when the luminance signal differs from the color-difference signal in the prediction processing, the same or different prediction methods may be used. When the different prediction methods are used for the luminance signal and the color-difference signal, the prediction method selected for the color-difference signal can be encoded and decoded by the same method as that for the luminance signal.

In the first and second embodiments, a syntax element that is not defined in an embodiment can be inserted into a line space of a table shown in the syntax configuration, and a description related to other conditional branching may be included. Alternatively, the syntax table may be divided or integrated into a plurality of tables. It is not always necessary to use the identical term and the term may arbitrarily be changed according to an application mode.

Instructions shown in the processing procedures described in the above embodiments can be carried out based on a program as software. A general-purpose computer system can obtain the same effect as that by a moving image encoding apparatus and a moving image decoding apparatus in the aforementioned embodiments by storing the program in advance and reading the program. Instructions described in the aforementioned embodiments are recorded in a magnetic disk (such as a flexible disk and a hard disk), an optical disk (such as CD-ROM, CD-R, CD-RW, DVD-ROM, DVD±R, and DVD±RW), a semiconductor memory, or similar recording media as a program a computer can execute. Any storage format can be adopted for a recording medium that can be read by a computer or an embedded system. The computer reads a program from the recording medium and causes a CPU to carry out instructions described in the program based on the program to be able to realize operations similar to those of a moving image encoding apparatus and a moving image decoding apparatus in the aforementioned embodiments. When the computer acquires or reads a program, the computer may naturally acquire or read the program through a network.

An OS (operating system) running on a computer, database management software, MW (middleware) of a network or the like may perform a portion of pieces of processing to realize the present embodiment based on instructions of a program installed from a recording medium into the computer or embedded system.

Further, the recording medium in the present embodiment is not limited to media independent of the computer or embedded system and includes recording media that store or temporarily store a program transmitted by a LAN or the Internet by downloading. The program performing the pieces of processing of each of the aforementioned embodiments may be stored in a computer (server) connected to a network, such as the Internet, and downloaded to a computer (client) through the network.

The number of recording media is not limited to one and a case when the pieces of processing in the present embodiment are performed from a plurality of media is also included in recording media according to the present embodiment and the media may be configured in any way.

The computer or embedded system according to the present embodiment is intended to perform the pieces of processing according to the present embodiment based on a program stored in the recording medium and any configuration such as one apparatus like a computer and a microcomputer, or a system in which a plurality of apparatuses are connected through a network may be adopted.

The computer in the present embodiment is not limited to a personal computer and includes a processor, a microcomputer and the like included in an information processing apparatus, and is a generic name for devices and apparatuses capable of realizing functions in the present embodiment by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving image encoding method for performing an inter prediction, the method comprising:
acquiring first predicted motion information and second predicted motion information from an encoded region including blocks including motion information; and
generating, if a first condition is satisfied, a predicted image of an target block using one of (1) the first predicted motion information and third predicted motion information, the third predicted motion information being acquired from the encoded region and being different from the first predicted motion information and the second predicted motion information, and (2) one of the first predicted motion information and the second predicted motion information, wherein
the first condition includes at least one of
(A) a reference frame referred to by the first predicted motion information and a reference frame referred to by the second predicted motion information are identical,
(B) a block referred to by the first predicted motion information and a block referred to by the second predicted motion information are identical,
(C) a reference frame number contained in the first predicted motion information and a reference frame number contained in the second predicted motion information are identical,
(D) a motion vector contained in the first predicted motion information and a motion vector contained in the second predicted motion information are identical, and
(E) an absolute value of a difference between the motion vector contained in the first predicted motion information and the motion vector contained in the second predicted motion information is equal to or less than a predetermined value.

2. The method according to claim 1, wherein the generating comprises generating the predicted image of the target block using one of the first predicted motion information and the second predicted motion information if the (2) is used.

3. The method according to claim 1, wherein the third predicted motion information satisfies at least one of
(A) being motion information of a block which is in a position spatially different from a position of the block from which the second predicted motion information is acquired,
(B) being motion information of a block in a reference frame temporally different from a reference frame including a block from which the second predicted motion information is acquired,
(C) being motion information containing a reference frame number different from a reference frame number contained in the second predicted motion information, and
(D) being motion information containing a motion vector different from a motion vector contained in the second predicted motion information.

4. The method according to claim 1, wherein the first condition is that the reference frame referred to by the first predicted motion information and the reference frame referred to by the second predicted motion information are identical.

5. The method according to claim 1, wherein if the inter prediction is performed by applying different weighted prediction parameters to a same reference frame, the same reference frame to which the different weighted parameters are allocated are regarded as different reference frames.

6. A moving image encoding apparatus performing an inter prediction, the apparatus comprising:
a predicted motion information acquiring module configured to acquire first predicted motion information and second predicted motion information from an encoded region including blocks including motion information; and
an inter-predictor configured to generate, if a first condition is satisfied, a predicted image of a target block using one of (1) the first predicted motion information and third predicted motion information, the third predicted motion information being acquired from the encoded region and being different from the first predicted motion information and the second predicted motion information, and (2) one of the first predicted motion information and the second predicted motion information, wherein
the first condition includes at least one of
(A) a reference frame referred to by the first predicted motion information and a reference frame referred to by the second predicted motion information are identical,
(B) a block referred to by the first predicted motion information and a block referred to by the second predicted motion information are identical,
(C) a reference frame number contained in the first predicted motion information and a reference frame number contained in the second predicted motion information are identical,
(D) a motion vector contained in the first predicted motion information and a motion vector contained in the second predicted motion information are identical, and
(E) an absolute value of a difference between the motion vector contained in the first predicted motion information and the motion vector contained in the second predicted motion information is equal to or less than a predetermined value.

7. The apparatus according to claim 6, wherein the inter-predictor generates the predicted image of the target block using one of the first predicted motion information and the second predicted motion information if the (2) is used.

8. The apparatus according to claim 6, wherein the third predicted motion information satisfies at least one of
(A) being motion information of a block which is in a position spatially different from a position of the block from which the second predicted motion information is acquired,
(B) being motion information of a block in a reference frame temporally different from a reference frame including a block from which the second predicted motion information is acquired,
(C) being motion information containing a reference frame number different from a reference frame number contained in the second predicted motion information, and
(D) being motion information containing a motion vector different from a motion vector contained in the second predicted motion information.

9. The apparatus according to claim 6, wherein the first condition is that the reference frame referred to by the first predicted motion information and the reference frame referred to by the second predicted motion information are identical.

10. The apparatus according to claim 6, wherein if the inter prediction is performed by applying different weighted prediction parameters to a same reference frame, the same reference frame to which the different weighted parameters are allocated are regarded as different reference frames.

11. A moving image decoding method of performing an inter prediction, the method comprising:
acquiring first predicted motion information and second predicted motion information from a decoded region including blocks including motion information; and
generating, if a first condition is satisfied, a predicted image of a target block using one of (1) the first predicted motion information and third predicted motion information, the third predicted motion information being acquired from the decoded region and being different from the first predicted motion information and the second predicted motion information, and (2) one of the first predicted motion information and the second predicted motion information, wherein
the first condition includes at least one of
(A) a reference frame referred to by the first predicted motion information and a reference frame referred to by the second predicted motion information are identical,
(B) a block referred to by the first predicted motion information and a block referred to by the second predicted motion information are identical,
(C) a reference frame number contained in the first predicted motion information and a reference frame number contained in the second predicted motion information are identical,
(D) a motion vector contained in the first predicted motion information and a motion vector contained in the second predicted motion information are identical, and
(E) an absolute value of a difference between the motion vector contained in the first predicted motion information and the motion vector contained in the second predicted motion information is equal to or less than a predetermined value.

12. The method according to claim 11, wherein the generating comprises generating the predicted image of the target block using one of the first predicted motion information and the second predicted motion information if the (2) is used.

13. The method according to claim 11, wherein the third predicted motion information satisfies at least one of
(A) being motion information of a block which is in a position spatially different from a position of the block from which the second predicted motion information is acquired,
(B) being motion information of a block in a reference frame temporally different from a reference frame including a block from which the second predicted motion information is acquired,
(C) being motion information containing a reference frame number different from a reference frame number contained in the second predicted motion information, and
(D) being motion information containing a motion vector different from a motion vector contained in the second predicted motion information.

14. The method according to claim 11, wherein the first condition is that the reference frame referred to by the first predicted motion information and the reference frame referred to by the second predicted motion information are identical.

15. The method according to claim 11, wherein if the inter prediction is performed by applying different weighted prediction parameters to a same reference frame, the same reference frame to which the different weighted parameters are allocated are regarded as different reference frames.

16. A moving image decoding apparatus performing an inter prediction, the apparatus comprising:
a predicted motion information acquiring module configured to acquire first predicted motion information and second predicted motion information from a decoded region including blocks including motion information; and
an inter-predictor configured to generate, if a first condition is satisfied, a predicted image of a target block using one of (1) the first predicted motion information and third predicted motion information, the third predicted motion information being acquired from the decoded region and being different from the first predicted motion information and the second predicted motion information, and (2) one of the first predicted motion information and the second predicted motion information, wherein
the first condition includes at least one of
(A) a reference frame referred to by the first predicted motion information and a reference frame referred to by the second predicted motion information are identical,
(B) a block referred to by the first predicted motion information and a block referred to by the second predicted motion information are identical,
(C) a reference frame number contained in the first predicted motion information and a reference frame number contained in the second predicted motion information are identical,
(D) a motion vector contained in the first predicted motion information and a motion vector contained in the second predicted motion information are identical, and
(E) an absolute value of a difference between the motion vector contained in the first predicted motion information and the motion vector contained in the second predicted motion information is equal to or less than a predetermined value.

17. The apparatus according to claim 16, wherein the inter-predictor generates the predicted image of the target block using one of the first predicted motion information and the second predicted motion information if the (2) is used.

18. The apparatus according to claim 16, wherein the third predicted motion information satisfies at least one of
(A) being motion information of a block which is in a position spatially different from a position of the block from which the second predicted motion information is acquired,
(B) being motion information of a block in a reference frame temporally different from a reference frame including a block from which the second predicted motion information is acquired,
(C) being motion information containing a reference frame number different from a reference frame number contained in the second predicted motion information, and
(D) being motion information containing a motion vector different from a motion vector contained in the second predicted motion information.

19. The apparatus according to claim 16, wherein the first condition is that the reference frame referred to by the first predicted motion information and the reference frame referred to by the second predicted motion information are identical.

20. The apparatus according to claim 16, wherein if the inter prediction is performed by applying different weighted prediction parameters to a same reference frame, the same reference frame to which the different weighted parameters are allocated are regarded as different reference frames.
